(19) United States
(12) Patent Application Publication
(10) Pub. No.: US 2002/0073119 A1
(43) Pub. Date: Jun. 13, 2002

(54) Converting data having any of a plurality of markup formats and a tree structure

(75) Inventor: Pierre G. Richard, Montpellier (FR)

Correspondence Address: HOGAN & HARTSON L.L.P., 500 S. GRAND AVENUE, SUITE 1900, LOS ANGELES, CA, 90071-2611, US

(73) Assignee: Brience, Inc.

(21) Appl. No.: 09/904,170

(22) Filed: Jul. 11, 2001

(30) Foreign Application Priority Data
Jul. 12, 2000 (FR) 0009105

(51) Int. Cl. G06F 15/00

(52) U.S. Cl. 707/513

(57) ABSTRACT

The content of Web sites or other information within a markup format is automatically translated using an appropriate script written in the conversion language to “blindly” process a large number of Web sites. These implementations may employ an ECMAScript interpreter, a tier architecture, an SGML parser and dynamic tree-to-tree transformations. The tier architecture is used to control multiple target requests, grouping and organizing responses into markup documents. The SGML parser can provide fault-tolerant analysis of markup documents to make them conform to XML standards. The SGML parser can generate the tree of the resulting document as a dynamic mode representing the content of the original data. Dynamic tree-to-tree transformation is provided in general via a “template/match/select” script, and may also use such tools as an ECMAScript interpreter, a regular expression search, direct access to nodes by DOM navigation, and a transformation and service environment.

### PRIORITY AND RELATED APPLICATION

The present application claims priority under 35 U.S.C. § 119 from French patent application No. 0009105, filed on Jul. 12, 2000, which application is hereby incorporated by reference in its entirety.

### BACKGROUND OF THE INVENTION

1. Field of the Invention

The present invention relates to conversion of data, and in particular to conversion of marked-up data.

2. Description of the Related Art

The 1990s saw widespread use of both the Internet and wireless portable devices such as telephones and electronic assistants. Today it appears that these two techniques of electronic communication will eventually unify as industrial giants of telephony and computing have made reciprocal agreements signaling this unification.

The format of data circulating on the Internet obeys precise international standards that apply to all layers that exchange data. For example, the transport layer of Transmission Control Protocol/Internet Protocol (TCP/IP), the request/response protocol called Hyper Text Transport Protocol (HTTP), and the content of the response itself (i.e., the web page) all obey these precise international standards. HTML is the standard markup language used to describe a web page. Markup languages use markup tags, or character sequences distinguished from the text, that are enclosed in special characters “<” and “>” to create a hierarchy within the text. The syntax of writing the markup tags makes it possible to distinguish the markup tags from normal text. A parser in the software decodes the marked-up document. By analyzing the hierarchy of the markup tags, a web browser can decide typographic rendering of each portion of the text: titles, paragraphs, tables, and images.

The hierarchy of the markup tags is also subject to rules. The Standard Generalized Markup Language (SGML) standard first formalized these rules in terms of the syntax of writing and describing the hierarchical constraints. The SGML standard is not, itself, a markup language. Instead, the SGML standard is a generic standard that provides a purely formal description defining the rules common to all markup languages. The SGML standard does not specify what markup tags a particular application should use.

The markup of many existing web pages is at best mediocre. While the HTML markup language requires that a web page contains a sequence of well-defined fixed markup tags and markup rules that conform to the SGML standard, in practice most existing information on the Web conflicts with the rules prescribed by the SGML standard. Early in the history of the Internet, web browsers lacked tools for validating that web pages conformed to rules of the SGML standard. As a result, many web page designers designed web pages that would provided quality typographic rendering when viewed on the screen of a computer using these standard browsers, without conforming to complex rules that were part of the SGML standard. The absence of these validation tools in web browsers allowed for proliferation of millions of web pages that do not conform to the SGML standard. As a result, much of the data on existing Internet sites is designed only for the unique and specific purpose of being viewed on the screen of a computer using standard web browsers. The reuse of these web pages with other applications, for example, when viewing them on the display of a portable telephone, may not be possible without a degradation of the content.

Realizing the extent of markup errors present in most web pages, many web browsers began to use validation tools. It was thought that validation tools might influence web designers to correct existing markup errors, while deterring web designers from producing new web pages including markup errors. This approach had only limited success. As an alternative solution, in the late 1990s, a consortium called W3C published the eXtensible Markup Language (XML) standard.

The XML standard is derived from the SGML standard. The XML standard simplifies the SGML standard, while also reinforcing the syntax in a strict manner. The XML standard has been used in a wide variety of applications. For example, in portable telephones accessing the Internet the WML markup language, which scrupulously respects the XML standard, has been used. Database designers are providing means of extracting content in an XML format. The “Electronic Data Interchange” (EDI) specification is also in the process of XML standardization. Nevertheless, the strict rules of the XML standard can weaken the SGML standard upon which the XML standard is based since the SGML standard is more permissive with respect to omissions of tags.

The goal of markup is to provide information about the role of a particular portion of the information (text, image) without making presumptions about the end use thereof. Each specific application processing these documents proceeds in a manner that is suitable for that application. Thus, to produce documents that are accessible to many diverse applications, it is important to respect the hierarchical rules for tags.

As a derivative of the SGML standard, the XML standard is also “generic” in the sense that it is not itself a markup language. A web page which would respect the XML standard can be written in the “eXtended HyperText Markup Language” (XHTML). As a result, one issue which arises with such a web page is how to process the information contained in the web page such that it can be presented on a portable telephone having fundamentally different characteristics than a personal computer.

In response, a group called the “Wireless Application Protocol” (WAP) Forum has made recommendations for producing a document that can be viewed on a cellular telephone. In particular, the WAP Forum has proposed a “Wireless Markup Language” (WML) standard. As shown schematically in FIG. 1, according to the WML standard, a “super document” is first designed in XML format. This “super document” can then be transformed by an “eXtensible Style Language” (XSL) transformation process. Depending on the particular “script” used during the XSL transformation process, code may be generated in either HTML or WML. The “script” is a style sheet in XSL format. According to these techniques, new documents are created, part-by-part, such that an appropriate transformation by an XSL script can reconstitute an HTML version of the document. Unfortunately, these techniques do not seek to reuse the existing HTML documents.

Existing web sites may be reluctant to accept the techniques proposed by the WAP Forum as many web sites will not change due to the lack of time for rewriting and/or since those sites have already invested a great deal in writing their pages in HTML and/or in creating automatic scripts in the CGI and JavaScript languages. Moreover, although the XML language simplifies the syntax of the SGML language, the XML language still must respect the hierarchy of markup tags. As such, a massive generalization of the XML/XSL approach may not be realistic.

### SUMMARY OF THE PREFERRED EMBODIMENTS

An aspect of the present invention provides a method of converting input data marked up in any one of a plurality of markup formats. The method includes providing the input data from at least one source, the input data marked up in at least one of a plurality of markup formats. The method continues by processing the input data directly in any one of the plurality of markup formats to transform the input data into output data in any one of the plurality of markup formats.

Another aspect of the present invention provides a system adapted to convert input data marked up in any one of a plurality of markup formats. The system includes means for providing the input data from at least one source, the input data marked up in at least one of a plurality of markup formats. The system further includes means for processing the input data directly in any one of the plurality of markup formats to transform the input data into output data in any one of the plurality of markup formats.

Another aspect of the present invention provides a multi-tier information architecture having tiers connected by a computer network. The architecture preferably includes a data consultation tier at a client station, an application tier on a server, a data source tier comprising a plurality of independent data sources, and a data aggregation tier. The data aggregation tier includes a conversion system adapted to convert input data marked up in any one of a plurality of markup formats. The conversion system includes means for providing input data from at least one of the independent data sources, the input data marked up in at least one of a plurality of markup formats, and means for processing the input data directly in any one of the plurality of markup formats to transform the input data into output data in any one of the plurality of markup formats.

Still another aspect of the present invention provides a multi-tier information/telephone architecture having a plurality of tiers connected by a computer network and by wireless telephone network. The architecture includes a data consultation tier for data consultation on a portable wireless communicator, a transport tier for wireless data transport, a data source tier comprising at least one data source, and a conversion tier. The conversion tier comprises a conversion system adapted to convert input data marked up in any one of a plurality of markup formats. The conversion system includes means for providing the input data from the at least one data source, the input data marked up in at least one of a plurality of markup formats. The conversion system further includes means for processing the input data directly in any one of the plurality of markup formats to transform the input data into output data in any one of the plurality of markup formats.

### BRIEF DESCRIPTION OF THE DRAWINGS

Aspects and various advantages of the present invention are described below with reference to the various views of the drawings, which form a part of this disclosure.

FIG. 1 shows a block schematic diagram of a conventional approach for adapting the same content to different physical and logical environments in navigating the Web.

FIG. 2 shows a block schematic diagram of one approach selected by embodiments of present invention for adapting the same content to different physical and logical environments in navigating the Web.

FIG. 3 shows a block schematic diagram of embodiments according to the present invention.

FIGS. 4 and 5 illustrate examples of tier architectures in which the system of this invention can be implemented.

FIGS. 6 and 7 illustrate, in varying levels of detail, transformations of a tree performed according to embodiments of the present invention.

FIGS. 8 through 15 show fragments of scripts written in the ECMAScript language and used in embodiments of the present invention.

FIG. 16 illustrates a tree structure of one part of a starting document used in embodiments of the present invention.

FIGS. 17 and 18 show fragments of scripts written in the ECMAScript language and used in embodiments of the present invention.

FIG. 19 illustrates an example of a source document and of a document converted according to embodiments of the present invention.

FIGS. 20 through 27 illustrate different parts of a debugging log that can be generated by embodiments of the present invention.

FIG. 28 illustrates a document type definition defining the format of the conversion scripts used by embodiments of the present invention.

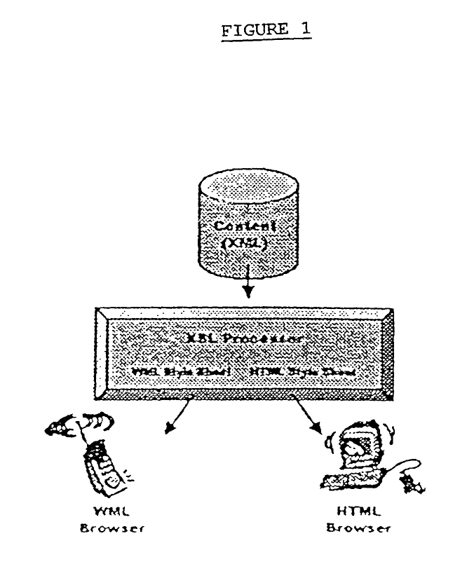

### DETAILED DESCRIPTION OF THE PREFERRED EMBODIMENTS

The present invention now will be described more fully hereinafter with reference to the accompanying drawings, in which preferred embodiments of the invention are shown. This invention may, however, be embodied in many different forms and should not be construed as limited to the embodiments set forth herein; rather, these embodiments are provided so that this disclosure will be thorough and complete, and will fully convey the scope of the invention to those skilled in the art. Like numbers refer to like elements throughout.

The description below discusses the XML standard, as well as many of the other concepts, specifications and standards. The specifications and standards to which this description refers are described on the web site of the W3C consortium at the URL http://www.w3.org. Additional specifications and standards to which this description refers are described at the URL http://org.w3c.dom.

Although the description below assumes that XML is used as a universal format for structured data, the embodiments of the invention also can function using other markup formats. Thus, the present invention described herein does not have any dependency on any particular markup format. As discussed herein references are made to the ECMAScript specification and DOM specification which are herein incorporated by reference in their entirety. Although embodiments of the invention are described in the context of the ECMAScript and DOM specifications, the invention is independent of and may be equally applicable to other specifications.

Embodiments of the present invention relate to data conversion for communication of data over networks. The data conversion techniques implement an extremely flexible conversion mechanism that does not require that input data be standardized in XML or that the input data strictly respect a hierarchy of tags. As a result, transformations may be performed on existing HTML web pages, including those with tagging errors, without rewriting web pages in an XMLcompatible manner and without requiring that this data first be retagged. To perform such conversions, aspects of the present invention also provide an instruction-writing syntax that is particularly simple to implement. Aspects of the present invention also provide a fault-tolerant validating SGML parser that utilizes complex algorithms for resolving most of the markup anomalies. The SGML parser produces a stream of data in strict conformity with the XML standard.

The content of Web sites or other information within a markup format is automatically translated using an appropriate script written in the conversion language to “blindly” process a large number of Web sites. These implementations may employ an ECMAScript interpreter, a tier architecture, an SGML parser and dynamic tree-to-tree transformations. The tier architecture is used to control multiple target requests, grouping and organizing responses into markup documents. The SGML parser can provide fault-tolerant analysis of markup documents to make them conform to XML standards. The SGML parser can generate the tree of the resulting document as a dynamic mode representing the content of the original data. Dynamic tree-to-tree transformation is provided in general via a “template/match/select” script, and may also use such tools as an ECMAScript interpreter, a regular expression search, direct access to nodes by DOM navigation, and a transformation and service environment.

Implementations of preferred aspects of the present invention can adapt data currently existing on web sites for processing in a wide variety of applications. For example, some of the possible applications include electronic commerce applications, conversion of web pages for wireless equipment, competition tracking by intelligent analysis of content, and generation of multimedia streams from multiple sources (e.g., music, images, etc.). Some implementations can also produce data that can be used by portable telephones accessing the Internet. Since access to resources is centralized, the implementations can provide security and are easily deployed. They can also provide an “open” architecture that takes advantage of and optimizes standard techniques used on the Internet. For example, the implementations may use HTTP as a transfer protocol, XML as a universal format for structured data, and ECMAScript as a transformation language.

Conversion of input data marked up in any one of a plurality of markup formats is provided. Input data are received from at least one source and the input data are processed directly in any one of the plurality of markup formats to transform the input data into output data in any one of the plurality of markup formats. In processing, first and second requests are typically generated. Input data from the at least one source are accessed in response to the first request. The input data are standardized to generate standardized data in one of the plurality of markup formats. The standardized data are then transformed into output data in any one of the plurality of markup formats in response to the second request.

The input data can be an input document having a first tree structure of nodes that represents the input data, and the output data can be an output document. The standardized data can be transformed by generating the output document having a second tree structure of nodes that corresponds to the input document having the first tree structure of nodes. In particular, the standardized data can be transformed into output data by selecting at least one transformation script from a plurality of transformation scripts. The at least one transformation script can comprise a plurality of template procedures. The standardized data are then read and interpreted, and the at least one transformation script can be applied to the standardized data in one of the plurality of markup formats to transform the standardized data into output data in any one of the plurality of markup formats applicable in a particular application. The at least one transformation script can be applied by selecting at least one template procedure from the plurality of template procedures, and then determining content collection actions in the at least one template procedure. Selected ones of the at least one template procedure can be executed to the standardized data to construct the output data, based on the content collection actions. A multi-tier information architecture is also provided that incorporates the conversion techniques described above.

Specific embodiments of the invention will be described in detail. The following is a description of document trees, document conversion, conversion scripts, and a functional description of the conversion language preferably used by embodiments of the present invention.

Document Tree

Conversion of information proceeds by examining the content of the information while also accounting for significance of the information within a context: data of a paragraph, a hypertext link, an image, a sound, a credit card number, etc. Preferred methods and implementations convert content as a function of context by applying a fundamental theory of data processing known as tree theory. In tree theory, any document that is correctly marked up may be represented as a tree having branches and any number of subbranches. The characteristics of the tree (for example, branches and leaves) are described, as well as a description for navigation within the tree (for example, how to find an ancestor in a genealogical tree), and for transformation of the tree (for example, how to create a tree of first cousins).

Preferred methods and implementations use tree theory to represent a particular document as a tree. This tree may be described according to a “Document Object Model” (DOM) specification of the W3C consortium. The DOM specification recommends using DOM syntax to describe the document model as a (XML) document tree, with certain correspondence agent extensions (e.g., MATCHER type) that are intended to produce greater efficiency in tree traversals. The DOM specification also recommends utilizing dynamic script techniques such as “Dynamic HTML” (DHTML) to allow navigation among a document's tree nodes.

The DOM specification recommends using the XSL and “eXtensible Style Language Transformations” (XSLT) languages to transform the document tree. However, XSL/XSLT may not allow DOM navigation and might not allow use of the best programming tools. Instead, the transformation based on XSL language and XSLT transformations uses a classic “node selection/choice of template” approach recommended by the “Document Style Semantics and Specification Language” (DSSSL) standard. Although this approach is one of the positive points of the XSL language, application of the XSL language is relatively complex as it requires knowledge of a new programming language.

Document Conversion and Conversion Scripts

A conversion script configures the conversion or transformation of a document that is marked up according to this method and strategy. The conversion script is programmed in a conversion (or federating) language. The syntax of the conversion language may be written in ECMAScript language. The ECMAScript language is a simple language that is currently used by web programmers and is based on the ECMAScript standard. The characteristics of ECMAScript conversion language make it powerful, yet easy to apply. The conversion scripts are thus easily implemented and adapted. Use of the ECMAScript language can avoid the need to create a new syntax and often avoids going through scripts tagged according to the XSL language. The ECMAScript conversion language for this transformation can thus provide flexibility in the configuration of the conversion of any markup document. Additional information on the ECMAScript language is available at the URL http://www.ecma.ch.

The conversion script centralizes communication with the various independent functional modules required for conversion. The independent functional modules required for conversion can include, for example, a DOM module, a module for text analysis and searching, a module for writing the resulting document, an iteration module, a variable maintenance module, a module for creating Java objects, and a debugging module. The DOM module can provide access to tree nodes of the input document. The module for text analysis and searching may include a regular expression search engine. The module for writing the resulting document can include a filtering engine. The iteration module is used for traversal of the tree by selecting nodes. The variable maintenance module can be either at the global level, or in the service environment.

Functional Description of the Conversion Language

As noted above, many of the pages of electronic data existing on the Web violate the HTML standard and therefore cannot be processed. Embodiments of the invention can recover data existing on the web and standardize the data using fault-tolerant algorithms capable of recovering a “document tree” which conforms to the XML standard to provide conveniently designed markup documents that can be transformed by the conversion language. The library of conversion scripts (programs) is provided that are preferably written in the Java language (e.g., Java 1.2, 100% Pure Java). A converter tool (Xgate) corrects the documents to be converted, interprets the conversion script, and produces the result in a continuous stream. Given enough calculation power and available memory, a theoretically unlimited number of documents can be converted simultaneously.

According to preferred implementations of the invention, the content of Web sites may be automatically translated using an appropriate script written in the conversion language to “blindly” process a large number of Web sites. These implementations may employ an ECMAScript interpreter, a tier architecture, an SGML parser and dynamic tree-to-tree transformations. The tier architecture is used to control multiple target requests, grouping and organizing responses into markup documents. The SGML parser can provide fault-tolerant analysis of markup documents to make them conform to XML standards. The SGML parser can generate the tree of the resulting document as a dynamic mode representing the content of the original data. Dynamic tree-to-tree transformation is provided in general via a “template/match/select” script, and also by introducing other tools (ECMAScript interpreter, regular expression search, direct access to nodes by DOM navigation, transformation and service environment).

Functional Modules of the Converter

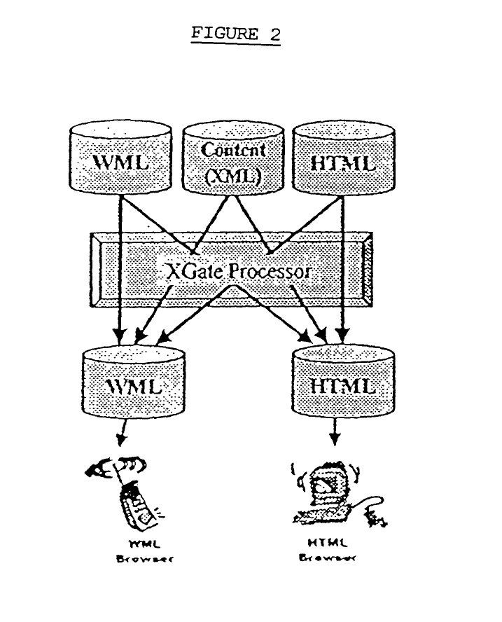

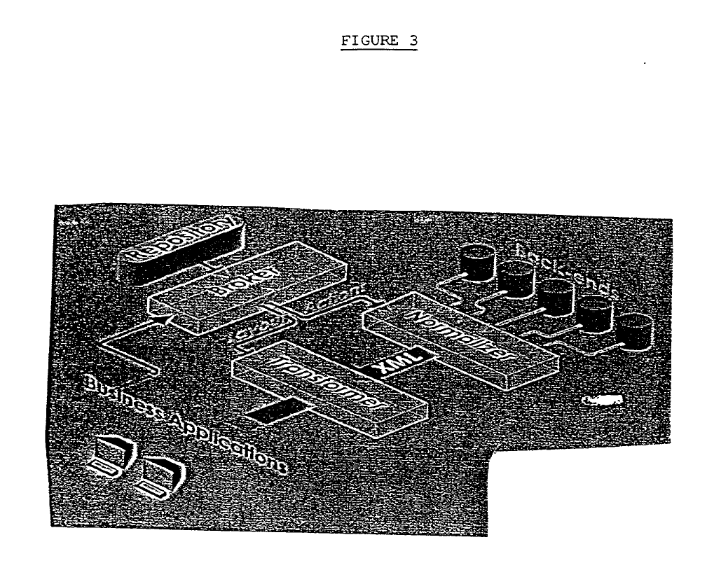

FIG. 3 shows a schematic diagram illustrating functional modules that comprise the conversion mechanism 240 (labeled as “X gate converter”) that is shown in FIG. 2.

The conversion mechanism 240 is preferably coupled between data sources 310 (labeled as “Back-ends” module) and application logic 320 (labeled as “Business Applications” module). The data sources 310 can supply source data. By separating the layers of access and application logic (transformation), embodiments of the present invention can provide extensibility and efficiency.

The application logic 320 or “Business Applications” module represents the logic of the client application, which is fed by data transformed by the XGate converter. The application logic 320 may be, for example, the application logic part of an electronic commerce application, as will be discussed further below. As indicated in this example, the “Business Application” may communicate by HTTP ports, constituting a specific tier at the TCP/IP level. In many cases, the application logic 320 or “Business Application” module can be absent. In this case, the client can communicate directly with the output of the XGate converter using any of a number of communication tools, such as, for example, a standard web browser.

A generator module 330 (labeled as “Broker”) can break down each request into orders intended for a standardization module 335 (labeled as “Normalizer”) and a transformation module 350 (labeled as “Transformer”). The “Broker” module 330 has access to a repository module 360 adapted to record the most common requests and profiles associated with repository module 360. For example, when information encoded in HTML is transformed into information encoded in WML, the repository module 360 knows the physical characteristics of the device submitting the request. Thus, when a portable telephone attempts to access information on web sites, for instance, the repository module 360 knows the model of a portable telephone and its physical characteristics, such as the dimensions of its display. It is also possible to know the profile of the caller, for example, the site preferences of the caller.

The standardization module 335 (labeled as “Normalizer”) can activate any number of data sources 310 in response to a request (labeled as “Actions” arrow), and return data therefrom in XML format. For a given request (labeled as “Actions” arrow), the number of XML documents generated depends on the number of data sources 310 activated. The standardization module 335 (or “Normalizer” module) can include a fault-tolerant parser component (not shown). The fault tolerant parser component may be, for example, an SGML parser. The SGML parser can provide fault-tolerant analysis of markup documents, and can make them conform to XML standards. A tree of the resulting document can then be generated representative of the content of the original data. The standardization module 335 can also contain other components such as a “Filter” component (not shown). If data from one of the data sources 310 (labeled as “Back-ends” module) accessed by the standardization module 335 is structured in a database, the “Filter” component of the standardization module 335 can generate markup specific to this type of request.

The transformation module 350 (labeled as “Transformer”) can respond to a request (“Layout” arrow) by reading a stream of XML output by the standardization module 335 (labeled as “Normalizer”). The transformation module 350 then applies at least one of a plurality of transformation script(s) to the stream of XML. The at least one of a plurality of transformation script(s) is chosen by the generator module 330 (labeled as “Broker”). Although not shown in FIG. 3, if necessary, the transformation module 350 can return a complementary request to the generator module 330.

### EXAMPLE 1

### Functional Architecture for an Electronic Commerce Application

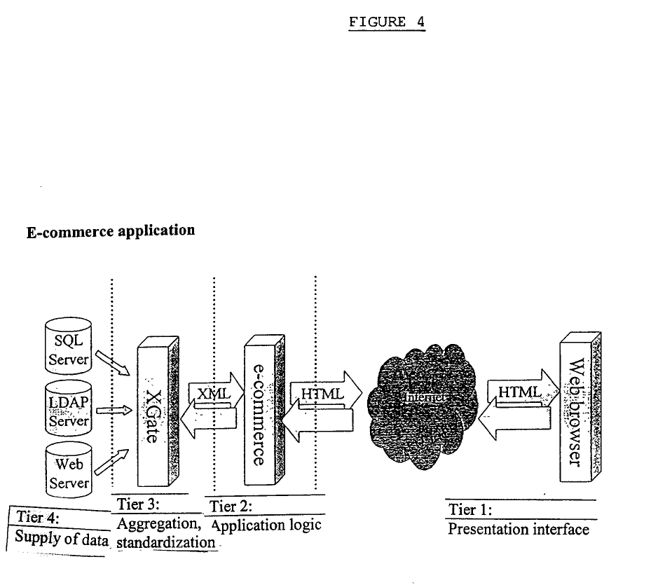

FIG. 4 shows an example of an electronic commerce application in which a converter 440 is integrated within a tier type architecture in which each tier has a well-defined responsibility. A converter 440 is similar to the converter 220 of FIG. 2. This particular electronic commerce application can provide clients with a catalog of products including images, prices, and/or addresses of vendors. Clients can then use a web browser, for example, to view the results of a client request.

In this particular application, the different information that is necessary comes from heterogeneous data sources. For example, prices come from an SQL server database 410, addresses come from an “Lightweight Directory Access Protocol” (LDAP) server 420, and web pages describing products that use for example text, images, and sound come from a “web server” 430. The “Lightweight Directory Access Protocol” is a standard protocol for searching information organized in a directory or a repository, such as the search for persons classified according to their name, company, country, etc. Embodiments of the present invention allow data from the heterogeneous data sources 410, 420, 430 to be easily modified and reused in different contexts.

The application logic 450 should preferably be freed from any questions relating to obtaining information that the application logic 450 processes. Moreover, the manner in which the information is physically displayed on the screen of the person requesting it is not the responsibility of the application. A web browser will translate the HTML stream output by the application logic in terms of display instructions. These display instructions will produce the corresponding output on the screen of the client computer. For example, the application logic 450 can produce a stream of HTML whose interpretation into images is performed on a presentation interface 470, for example a client computer at the level of the client station.

In this example, the converter 440 (or “XGate converter”) obtains or collects the heterogeneous data from the data sources 410, 420, 430. The converter 440 then standardizes this heterogeneous data by assembling the necessary information to produce a stream of standardized output data. The stream of standardized output data can be in any of number of markup languages. For example, the stream of standardized output data could be produced in XML language, since the flexibility of XML language makes it possible to define a markup structure that is appropriate in this particular application. The application logic 450 only specifies its needs in XML via a request/result conversion XF script.

Aggregation and Transformation

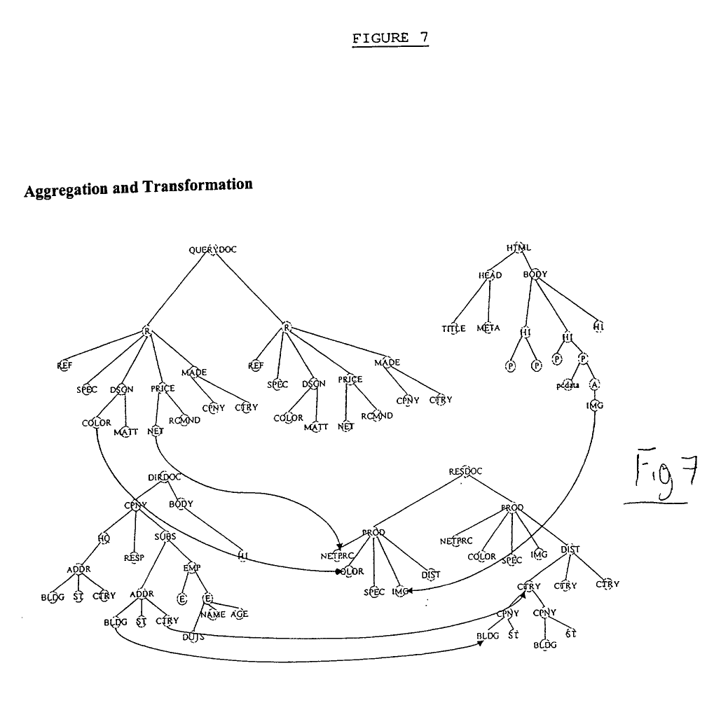

FIG. 7 shows a simplified version of the transformation taking place in the electronic commerce application described above in FIG. 4. Several steps performed by the XF conversion script during the transformation are illustrated.

The standardization interface 335 (labeled as “Normalizer” in FIG. 3) has created DOM trees of three XML documents resulting from the search of heterogeneous data sources 410, 420, 430. The DOM trees of three XML documents are QUERYDOC from a product search in the SQL server database 410, DIRDOC from an address search in the “Lightweight Directory Access Protocol” (LDAP) server 420, and an HTML document containing images from a “web server” 430.

Instead of using extremely complex “classical programming” to assemble the resulting document RESDOC, the converter 440 (labeled as “Xgate” in FIG. 4) performs searching of the DOM trees QUERYDOC, DIRDOC, and HTML and assembles them into the resulting document RESDOC. The XF conversion script constructs the resulting document RESDOC by selecting appropriate nodes in each of the DOM trees QUERYDOC, DIRDOC, and HTML. The model of the RESDOC document is specified in the application logic 450 of FIG. 4. Here the REDDOC document is shown as either an XML schematic diagram or in “Document Type Definition” (DTD) format.

Although FIG. 7 may suggest that the three trees are independent as the converter 410 constructs the three trees in parallel, construction of the three input trees is actually interdependent. For example, the search for a product in the SQL server database 410 gives the name of the distributor (CPNY), which in turn makes it possible to query the “Lightweight Directory Access Protocol” (LDAP) server 420 for its geographic coordinates. This principle of redirection uses the functions of the generator module 330 (labeled as “Broker” in FIG. 3), and is integrated into the conversion XF script via the services variables.

### EXAMPLE 2

### Functional Architecture for Conversion of HTML into WML

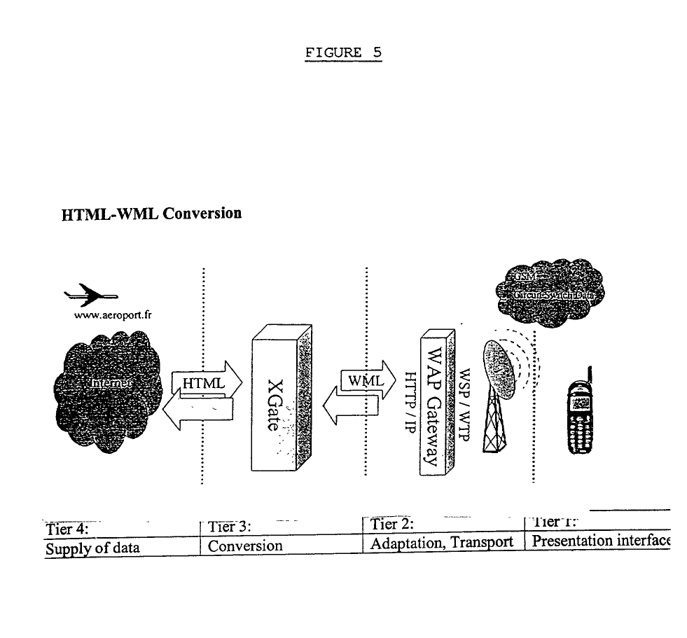

FIG. 5 shows a functional architecture for conversion of HTML into WML. Specifically, FIG. 5 illustrates an example in which airplane flight departure from and arrival schedules to French airports are accessed from a wireless communicator, for instance, a portable radiotelephone. Calling a private number from such a wireless communicator makes it possible to obtain updated flight schedules, delays and cancellations that are displayed on the wireless communicator in a readable manner.

In this example, the first tier comprises a presentation interface 570 which is a wireless communicator. The wireless communicator 570 can communicate with the GSM network in CSD mode or DATA mode.

At the second tier adaptation and transport are provided by a WAP gateway 560. One of ordinary skill in the art will appreciate that the adaptation and transport 560 are independent of the GSM technology used in this particular example in which adaptation and transport are provided by a “Wireless Session Protocol/Wireless Transaction Protocol” (WSP/WTP). The WSP/WST allows the XGate converter 540 to “see” the wireless communicator 570 as an IP device that issues a HTTP request and expects an HTTP response to be returned.

At the third tier, the converter 540 (labeled as the Xgate) engages in dialog with the web site in question, deciphers the information, and submits other requests until it obtains the information requested by the calling wireless communicator 570. Once the information requested is obtained, the converter 540 translates the response by generating the WML tags that are necessary to display this response in plain text on a display of the wireless communicator 570. The WML tags are generated using an XF conversion script, described above, which is responsible for configuring the transformation. The conversion scripts are written in a conversion language for the translation of target HTML sites to portable telephones. The XF conversion script is not very lengthy, as it typically does not exceed one page of code.

Transformation into a Stream

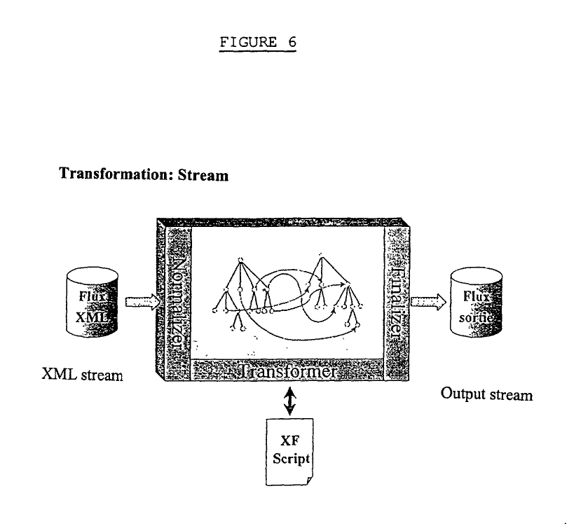

FIG. 6 shows a block diagram illustrating the function of the converter 640. In particular, FIG. 6 illustrates relationships between streams of data and standardization interface 635 (labeled as “Normalizer”), transformer interface 650 and finalizer interface 680 that comprise the converter 640. As shown in FIG. 6, the conversion work is performed in a continuous stream to provide a rapid response. Depending upon the particular transformation, a portion of the input data that is input first can be output before all of the input data has been read.

The standardization interface 635 (or “Normalizer”) builds an input tree based on the XML stream. As noted above, the continuous stream technique does not require that the input tree be completely constructed before beginning the transformation. Only if the transformation requests a branch that is not yet built, will the “Normalizer” interface 635 then read enough input data to build this branch.

The trees of the input and output documents can be defined in the DOM specification. FIG. 6 illustrates the node-to-node transformation of the trees of the input documents to trees of the output documents as defined by the DOM specification. Arrows within the box represent this node-to-node transformation. The “Transformer” interface 650 interprets an XF conversion script to guide this node-to-node transformation. XF conversion scripts will be discussed in detail below.

The “Finalizer” interface 680 provides the output stream by traversing the resulting DOM output tree. The output stream is provided continuously, unless one of the branches is incomplete. If one of the branches is incomplete, then only does the “Finalizer” interface 680 wait until the transformation of this branch is completed. The “Finalizer” interface 680 can also include filters (not shown) for filtering the output stream. For example, portable wireless communicators do not recognize the HTML encoding of accented characters since the document type definition (DTD) of the WML language does not include the encoding of accented characters. When this is the case, the “Finalizer” interface 680 can convert accented characters into the corresponding unaccented characters.

XF conversion scripts are particularly advantageous aspects of the described architecture, and will now be discussed in detail.

General Structure of an XF Conversion Script: Templates

On the syntactic level, an XF conversion script is a document in markup language that is composed of a list of procedures. Each procedure is applicable to nodes of a document that satisfy a well-defined condition. One example of a condition could be “is a node of the ‘paragraph’ type in the body of the document?”. A condition and a procedure associated with that condition are called templates. Examples of templates would be as follows:

Template A: for any node satisfying condition A, do (procedure A).

Template B: for any node satisfying condition B, do (procedure B).

. . .

Template Z: for any node satisfying condition Z, do (procedure Z).

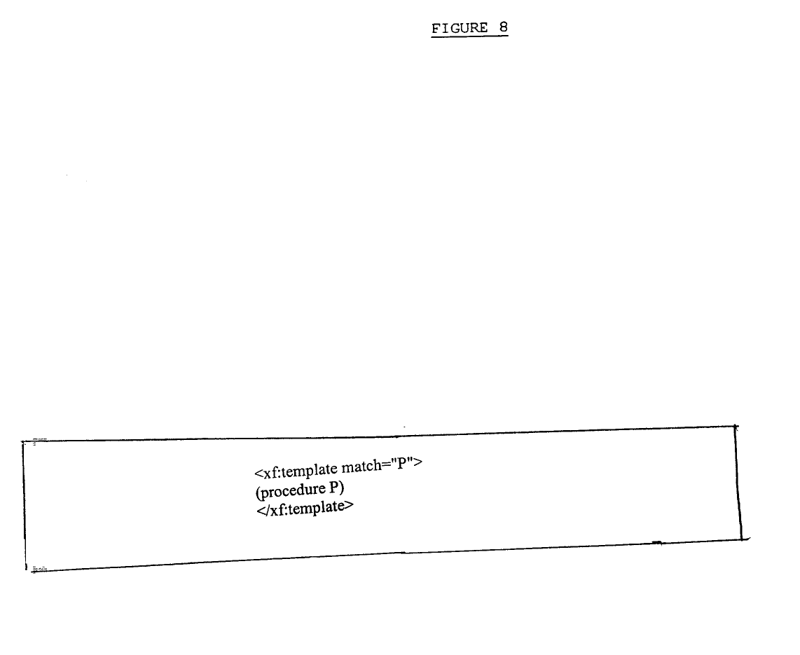

A pair of markup tags represents each template. The pair of markup tags includes one opening tag that signifies the beginning of a new template, and one closing tag that signifies the end of that template. The associated condition is the correspondence attribute “Match” of the opening tag. The procedure to execute is the content between the opening and the closing tag of the “template”. Thus, the clause “for any paragraph node of the body of the document, do (procedure P)” would be written as shown in FIG. 8.

According to embodiments of the present invention, the content of the template element is a “template procedure” in the ECMAScript language. Although this syntax appears to be similar to the syntax of the XSL language, as will be seen below, the syntax of the “Match” criterion is much simpler. Moreover, contrary to the “template” element of the XSL language (“xsl:template”), the XF template element does not contain any subtags. Programming of template procedures is now described.

Programming Template Procedures

Conversion is programmed in a natural manner. This results in code that is relatively simple, readable, and is not difficult to learn, while being especially powerful. Describing operations by a list of templates is an approach that is particularly well adapted to tree conversion.

In the Java language, the instruction “XF.” signifies that reference is made to a method of an XF object that is implicitly part of the environment of the conversion script. All instructions specific to the conversion tool begin with “XF.” By creating a template procedure whose subject object (“this”) is found at a current node, tree traversals and recurrences are easily implemented. For example, consider the following procedure:

XF.log.writeln(this.getNodeName( ))

This procedure is called for any paragraph in the document. The DOM specification defines a class of nodes called “Node” at “org.w3c.dom.Node”. Each template procedure represents a method of an object belonging to the class of nodes Node. All the methods defined by the DOM specification for the class of nodes called “Node” are applicable to a subject object (“this”) of the template procedure. The subject object (“this”) of each template procedure is the node object of the DOM tree that has satisfied the condition criterion of execution (“Match”). The subject object “this” is the DOM node for which this template is called. The call of the DOM function “getNodeName(” that is applied to the subject object “this” returns the word

Thus, the XF conversion script is composed of a list of template procedures with each procedure described by the “template” tag. For the conversion to be performed, the procedures are now executed. The manner in which the procedures are called will now be described.

Calling of the Template Procedures

As mentioned above, in the Java language, the instruction “XF.” signifies that reference is made to a method of an XF object that is implicitly part of the environment of the conversion script. All instructions specific to the conversion tool begin with “XF.” Template procedures are called by the method “applyTemplate(select)”. This method is one of the methods of the global object XF, and is written as follows:

XXF.applyTemplate(select)

Based on the value of the selection argument “select” (also known as a “traversal equation”) the method “applyTemplate( )” determines an order of searching and executing any template that is applicable to the nodes of the tree encountered during a specified traversal. The “applyTemplate( )” method generates a chain reaction. In order for the chain reaction device to start, the template procedure of the document's root node is automatically called. This is the only procedure that is called automatically. From the template procedure of the document's root node, the “applyTemplate( )” method is launched to call all of the template procedures according to the traversal equation. The template procedures that satisfy the “Match” condition of execution are activated. Since this mechanism can sometimes be difficult to control, the invention advantageously provides routines to debug the written script, which are developed to provide rapid means of correcting a recursion error.

The XF conversion language does not require complex selection of nodes. The selection argument “select” uses a simple syntax similar to that recommended by the “Text Encoding Initiative” (TEI) work group. By contrast, attempting to use the standard syntax of the XSL language would demonstrate the unsuitability of XSL equations to resolve real conversion conditions. The degree of complexity of the correspondence and selection equations would increase exponentially for each new condition. Moreover, the resultant equation may not be valid.

Administration of Cloistered and Service Environment Variables

The XF conversion language provides functions, which allow passing of “cloistered” variables between template procedures. These variables are called “cloistered” since a template procedure can create its own set of variables which can then be inherited by all the template procedures called by that template procedure. In this case, the “applyTemplate” method can additionally pass any number of variables per argument. Cloistered variables can be of any nature: integers, strings, arrays, or even ECMAScript objects (otherwise called “Dynamic Elements”). This flexibility considerably extends the power of this mechanism. A variable created by a cloister cannot be transferred to a parent cloister. Cloistered variables exist during execution of the XF conversion script in which they are defined. However, a session generally comprises several requests and therefore several conversions that can have certain variables in common. The XF conversion language provides this capability by service environment variables.

The values of the service environment variables are initialized and updated by the generator module 330 (labeled as the “Broker” module). The values of the service environment variables depend essentially on the calling service, and especially on the type of request arriving. For example, during transformation into WML code the identity of the caller and the model of the wireless communicator are variables that are recorded in the service environment.

Writing the Output Document

In the Java language, the instruction “XF.” signifies that reference is made to a method of an XF object that is implicitly part of the environment of the conversion script. All instructions specific to the conversion tool begin with “XF.” A method “XF.result( )” provides an object which can access the output document, while a method “XF.result( ).write( )” adds a piece of markup language to the output stream. When access is given to the root node of the output document, random access methods defined by the DOM model for adding nodes in a tree are can also be used to write the output document. Although these random access methods in writing coexist with the method “XF.result( ).write( )”, for even the most complex test scripts, these random access methods were seldom necessary.

Other Functions of the XF Conversion Language

The XF conversion language can provide other functions such as searching for text by using regular expressions, debugging trace level, and instantiation of Java objects. Nevertheless, the number of additional functions should be limited to preserve the simplicity and “federating power” of the XF conversion language.

Example of an XF Conversion Script

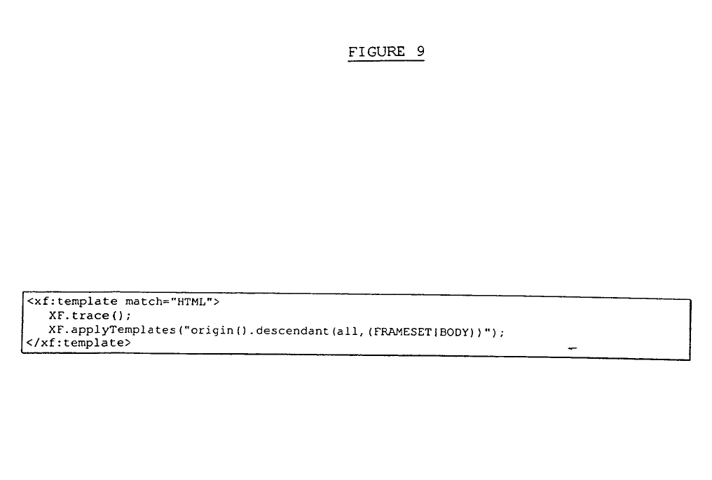

FIG. 9 shows code fragments from the conversion application described above in which a search for airplane flight schedules is conducted and the results of the search are displayed on a WAP telephone. While this conversion is described in the context of a search for airplane flight schedules in which the results of the search are displayed on a WAP telephone, this conversion can be applicable to other types of Internet searches.

An XF conversion script is a series of templates. FIG. 9 shows the first template called in the list of templates that make up the XF conversion script. This template is also known as a “base template”, and is called for the “HTML” node of the tree of the input document. In a web page, the “HTML” node is the root node of the document.

In the description of this particular conversion, the choice of airport is omitted for simplicity. Nevertheless such information could be included. In this particular conversion, a preliminary analysis of a map of a web site in question led to the following four rules:

(1) The process should be recursive. Most of the pages of the web site are organized into “frames” that define a rectangular portion constituting a subpart of a display screen of an HTML page. In many second generation web browsers, a HTML page is conceived as a mosaic or collection of frames, also know as a “frameset”. Each frame in a frameset has its own HTTP address. To find desired information in a particular frame, the contents of each of the frames must be examined. For any page in which a “FRAMESET” tag is encountered, the request should be redirected by requesting access to the page corresponding to each of the frames making up the frameset. In general, these frames can be created dynamically by CGI-type programs of the site being explored. These frames may be updated periodically. There is nothing preventing the page that is returned from containing another FRAMESET tag. Consequently, the process must be recursive.

(2) Redirections should loop until a specific page is found in the command. In particular, redirections should loop until a page of a table of schedules is found in the command or a page that offers the choice of departure or arrival schedules is found in the command. The page of the table of schedules is preferred.

(3) When the system is accessed on the “choice of schedules” page, it proposes this choice on the wireless communicator, waits the response from the user, and then resumes the process by directing the search to the desired departure or arrival schedule.

(4) When the page of schedules is finally found, the system converts the table of the web page from HTML format, into an appropriate format to display it on the wireless communicator display.

Therefore, the above-described conversion is coupled with preliminary navigation logic. In the architecture of the XGate converter, generator module 330 (labeled as “Broker”) is responsible for these successive redirections. As for the conversion, the generator module 330 (labeled as “Broker”) is not visible. Rather, the XF conversion script calls for successive redirections from the generator module 330 implicitly in a transparent manner. The XF conversion script is called for all pages to which the XF conversion script is addressed.

Base Template

As stated previously, an XF conversion script is a series of templates. FIG. 9 shows the first template called in the list of templates that make up the XF conversion script. This template is also known as a “base template”, and is called for the “HTML” node of the tree of the input document. In a web page, the “HTML” node is the root node of the document.

As mentioned previously, in the Java language, the instruction “XF.” signifies that reference is made to a method of an XF object that is implicitly part of the environment of the conversion script. Most preferably, all instructions specific to the conversion tool begin with “XF.” For example, the instruction “XF.trace( )” in the body of the template requests the XF object to produce a debugging trace in the files which monitors the progress and is called “log files”. The instruction “XF.applyTemplates( . . . )” requests the script to call all the template procedures corresponding to the nodes described by the traversal equation:

“origin( ).descendant(all,(FRAMESET|BODY))”.

This equation uses “XPointers” type syntax. This equation can be interpreted to mean: starting from the current node (i.e., “origin( )”) traverse all nodes descending from it (i.e., “descendant(all, . . . )”) whose names are either “FRAMESET” or “BODY”. The “FRAMESET” nodes stop the conversion to request access to the page to which they refer. The “BODY” nodes contain results to convert and display. In this particular conversion, only the nodes named “FRAMESET” or “BODY” should be taken into consideration, and these nodes will now be described in detail.

Looping through the Frames: FRAMESET Template and Redirection

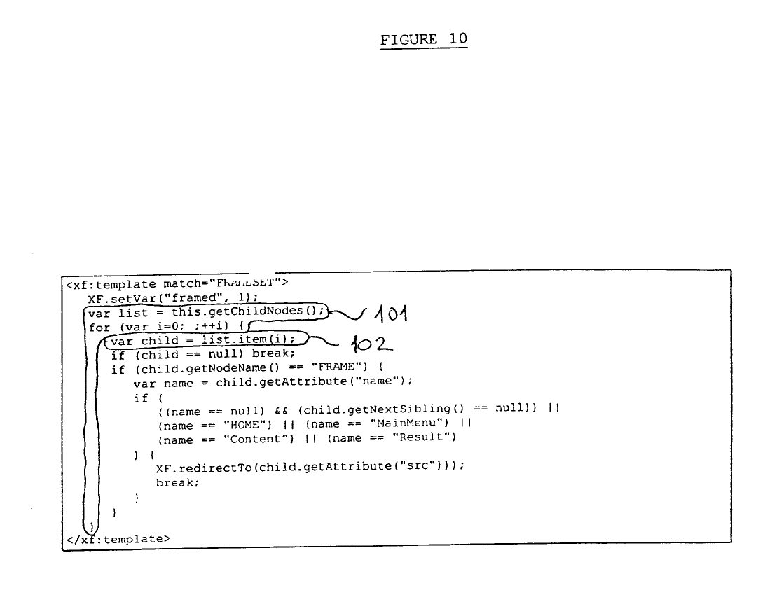

FIG. 10 shows a FRAMESET template called for the FRAMESET nodes. The first instruction of the FRAMESET template procedure, namely “XF.setVar(“frained”, 1)”, creates the cloistered variable “framed” and assigns it the value 1. The reason for this will now be explained.

The direct descendants (children) of the FRAMESET node are called FRAME nodes. These FRAME nodes are examined to find the FRAME node that describes the page to be accessed. As shown in FIG. 10, to find the FRAME node that describes the page to be accessed, the DOM model defines the “getChildNodes( )” method as part of a search loop 101. The search loop 101 of the page is a classic “for” loop. The “getChildNodes( )” method is used to return a list of all the children of a given node. The subject object “this” of the script of a template is the DOM node for which this template is called.

A standard class “org.w3c.dom.NodeList” of the DOM model defines that a list obtained has an object whose method “item(i)” is able to extract the i^{th} element from the list. Within the “for” loop, the instruction 102 can obtain in succession all the “FRAME” nodes (i.e., children of the “FRAMESET” node), until either there are no “FRAME” nodes remaining (i.e., when the “child” variable assumes the value “null”) or until the desired “FRAME” node in question is found.

As shown in the script of FIG. 10, the group of conditions expressed by the “if( . . . )” instruction controls a redirection operation. Specifically, the frames that are subject to the redirection operation are the frames named “HOME”, “MainMenu”, “Content”, or “Result”. In general, however, it is possible to expect that the names of the frames are less likely to change than are the other elements of the pages. Therefore, choosing the names of the frames as criteria subject to the redirection operation is a good choice. Embodiments of the present invention are not restricted to using these frames for the redirection operation. Rather, it should be appreciated that the names of these frames depend on the choice of program of the site, and therefore the names of these frames can change with time.

Moreover, the administrator of a site could be advised not to make changes, which could compromise the function of a conversion script, knowing that the obligation to freeze the name of a frame is not a real constraint for him. Thus, such a constraint does not hamper the future evolution of the site over time, and the necessary adaptations of the conversion script remain easy.

Redirection is triggered by the instruction “XF.redirectTo( . . . )”. The instruction “XF.redirectTo( . . . )” is a method that takes the HTTP address of the new page as a parameter. The HTTP address of the new page is the value of the “src” attribute of the “FRAME” node, obtained by the “getAttribute( )” method applied in the DOM model to the current frame or “child” node.

The generator module 330 (labeled as “Broker” in FIG. 3) makes it possible to manage several scripts at once. Redirection to another page restarts the conversion script with the data of the new page, and by default the same conversion script is called. If necessary, the method “XF.redirectTo( )” has an optional parameter indicating the name of the XF script which should be executed. In this case, the name of the XF script, which should be executed, is the value of the “name” attribute of the root tag <xf:doc>. In this case, the name of the XF script that should be executed takes precedence over any other XF script. In XF terminology, a change of script is called “mode change”. In combination with the dynamic change of conversion files “XF.load( )”, the possibility of multiple scripts (managed by the generator module 330) provides remarkable flexibility in the administration of conversions.

The navigation from “FRAME” node to “FRAME” node is done until the pertinent pages are accessed. These pages do not contain a “FRAMESET” tag. Moreover, the “BODY” tag of these pages contains the information sought. The BODY template will now be described in detail.

Conversion: The BODY Template

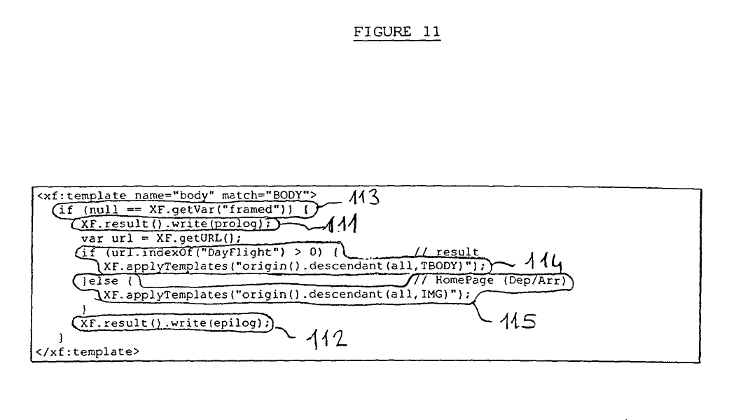

FIG. 11 shows a “BODY” template called for the “BODY” nodes. Write instruction 111 writes a prolog variable of the WML document into the output file and write instruction 112 writes an epilog variable of the WML document into the output file. Since the “prolog” and “epilog” variables are frequently used, they are defined only once as “string” fixes. Execution instruction 113 of this template is conditional and depends on the value of the “framed” variable. If this condition is true, then it is known that the “BODY” node is not in a page. Otherwise, the “FRAMESET” template would have created the “framed” variable that thus would not have had the value “null”.

The BODY of a page formed by frames is of no interest in this particular conversion. In the HTML language, a body tag can follow the FRAMESET tag. In this case, however, the content of the BODY is of no interest since browsers existing before the frame feature was introduced use the BODY of a page. Such a BODY tag displays text indicating the inability of the browser software to process documents containing frames. In this case, no other instruction of this template is executed, and since no other template is active the conversion is terminated at this stage.

In the other case, this page contains either the menu of the airport or one of the requested schedules. In this example, by examining the HTTP address (URL) of this page it possible to determine that the page is a menu if the page contains “HomePage”, and that the page is a schedule if the page contains “DayFlight”.

The address of the current page belongs to the service environment variables, and is obtained by the XF method “getURL( )”. The XF method “getURL( )” returns a string (e.g., an ECMAScript object of the standard “String” class) whose method “indexoOf( )” recognizes whether or not the address of the current page contains the string “DayFlight”. As shown in the navigation equation 114, if the page does contain the string “DayFlight”, then the page contains schedules in the form of an HTML table. The node named TBODY (for “table body”) of the HTML table should then be examined in the descendants of the BODY node.

Hypertext Navigation

Referring still to FIG. 11, when the address of the web page, in this example the airport home page, does not contain the string “DayFlight”, the content of the “else” clause 115 comes into play. At this point, intervention of the caller is necessary, and therefore the caller is prompted to determine whether the user wants to view departure schedules or arrival schedules. Depending on the response of the user, the appropriate page is then navigated.

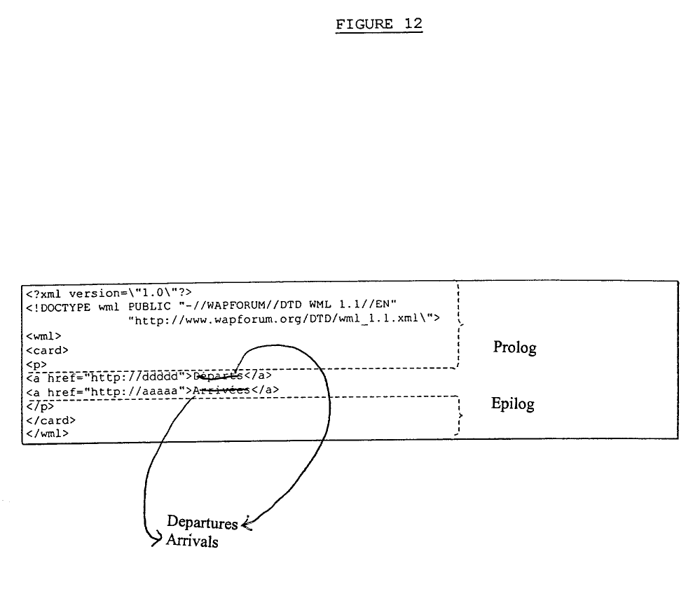

As shown in FIG. 12, the response of the user is obtained by sending a page in WML language to the WAP wireless communicator. The calling template procedure (BODY template) has already written the prolog of this WML page, and will write its epilog when it returns. Therefore, two lines containing the tag <a> can be generated, for example, by grafting two nodes having the tag <a> onto the output tree. The <a> tags are anchor points of hypertext navigation. The WML syntax of the <a> tags is similar to HTML syntax except that WML syntax requires that the letter “a” be lowercase.

Values of the href attributes “http://ddddd” and “http://aaaaa” are exemplary only, and in reality the values of the href attributes would actually be HTTP addresses of web pages that would allow navigating to either the departure schedules or the arrival schedules, respectively. When the caller activates the word “Departures” displayed on his WAP wireless communicator, he triggers navigation to the page, which is found at the HTTP address “ddddd”. These values of the href attributes appear in the HTML page during the course of conversion as the source attribute of the <A> tags in the HTML code of the web page, which are thus the nodes of the tree in the descendants of the current node “BODY”. Uppercase letter “A” is used for the HTML tag to make a clear distinction between the tag, which is sought in the HTML page of the input document, and the WML tag <a>, which must be generated in the output tree.

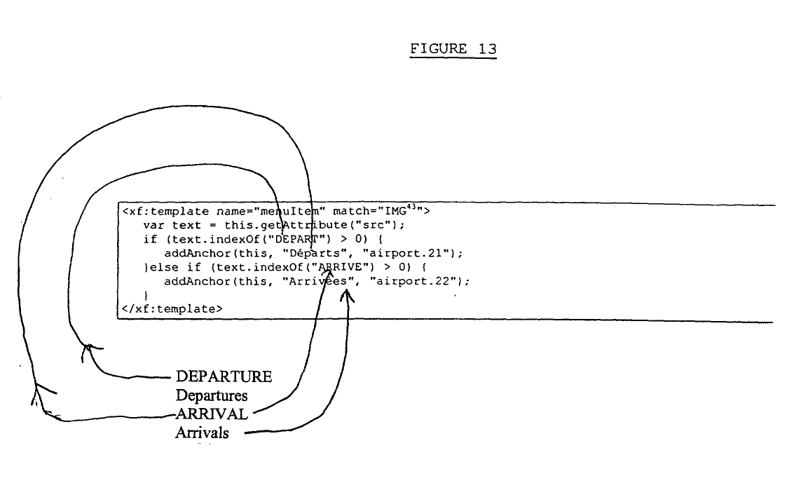

Next the nodes whose tags are <A> need to be located. Examination of the code of the HTML page shows that such nodes have an image type child node (“IMG”) whose “src” attribute contains either the word “DEPARTURE” or the word “ARRIVAL”. As shown on the second instruction line 115 in FIG. 11, all the “IMG” nodes should be examined to apply the templates to the descendants of the “IMG” type. The template associated with the image nodes is illustrated in FIG. 13. The correspondence equation “match=“IMG”” could be more complex by restricting the candidate MG nodes to only those whose parent is a type A node.

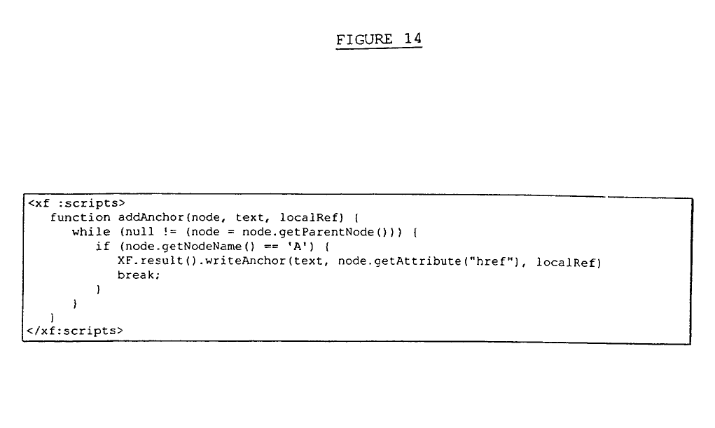

Any number of local routines or local variables can be defined. For example, the local string variables prolog and epilog mentioned above are local routines or local variables. As shown in FIG. 14, the element “xf: scripts” contains the function “addAnchor( )”. In this case, a programmer has assigned this routine to construct an anchor point. Activation of this anchor point from the WAP wireless communicator brings about navigation to the desired web page, here the departure and arrival schedules. In this template the function call “addAnchor( )” is neither the method of an object since its syntax does not read “subject.addAnchor( )”, nor is it an instruction defined by ECMAScript. Instead, the function call “addAnchoro” is a local function defined by the programmer of the XF script in question. Local functions (or “routines”) can allow the programmer to structure code such that it is reusable and readable. XF scripts offer these local functions or routines that can be called from any template, and appear in the content of the tab: <xf: script>.

During the first contact with a new caller on the wireless communicator or when there is a navigation error (HTTP code 404), a default XF script is called when the current mode is not defined. The default XF script includes a tag <xf:init> that defines the conversion procedure to apply when the source document to be converted does not exist. The root tag <xf:doc> of the default XF script either does not have the “name” attribute, or if it does have the “name” attribute the default XF script has an attribute whose value is the reserved word “#default”. This tag completes the list of tags appearing in the XF script.

As shown in FIG. 14, the routine contains a loop that searches for the first “A” node in the parental line of the current “IMG” node. When this node has been found, the routine calls the method “XF.result( ) writeAnchor( )”. The method “XF.result( ).writeAnchor( )” will now be described in detail.

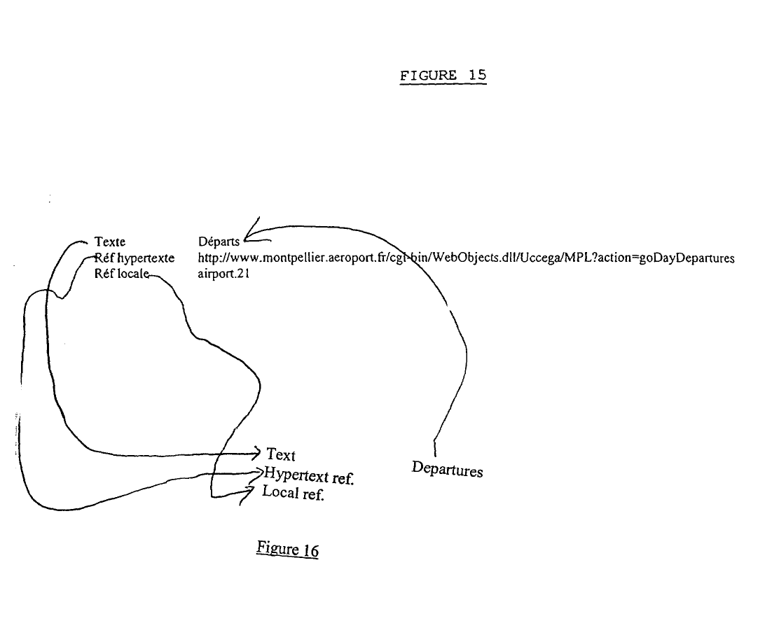

In general, the method “XF.result( )” makes it possible to access the output file (document) that will be sent to the WAP wireless communicator. The output file could be written in several ways. In this particular example a sequential write is performed. As discussed above, the output file could be written in random access by adding a node of the output DOM tree. The method “writeAnchor( )” of the “output file” object is obtained by the method “XF.result( )”. The method “writeAnchor( )” has the text of the anchor point associated with the hypertext reference: “Departures” or “Arrivals” as a first argument. The second argument of the method “writeAnchor( )” is a hypertext reference obtained by reading the value of the “href” attribute of the parent node of the <A> tag. The third argument of the method “writeAnchor( )” is a local reference that is the name to be associated with the hypertext reference. Sample values of these three arguments are shown in FIG. 15.

To obtain the conversion result, which in this example is the table of flight schedules, the following is written in the output file:

<a href=“/xxx/airport.21 ”>Departures</a>

where “xxx” identifies the session (the caller), “airport” identifies the mode of transformation (<xf:doc name−“airport”>), and “21” identifies the step.

The generator module 330 (labeled as “Broker” in FIG. 3) can reconstitute the real address of the page that supplies the result. The generator module 330 can also indicate the other references (caller, mode, etc.) called for the conversion of this page via the environment variables of the XF conversion script.

Displaying the Schedule Table

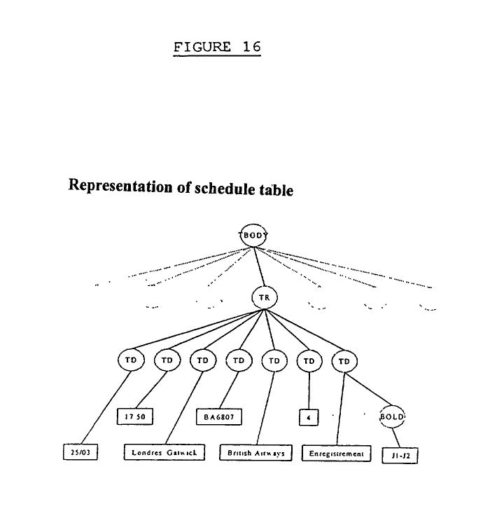

Referring now to FIG. 16, shown is a tree diagram that represents a document tree at the TBODY node. The TBODY node corresponds to the conversion result that in this example is the table of flight schedules. The document tree of FIG. 16 is common to any table in an HTML document.

The children of the TBODY node are the TR nodes. In this example, the TR nodes correspond to table lines that each corresponds to a flight. The children of the TR nodes are TD nodes. TD nodes represent the columns of the table. The TD nodes have descendants that are the actual text of each of the columns of the table. This text gives the characteristics of the flight. Although it is not shown in FIG. 16, the line of descent between a TD node and the associated text can be indirect, with an intervening node indicating the character font used.

To retrieve the text of each of the columns, the following navigation equation is used:

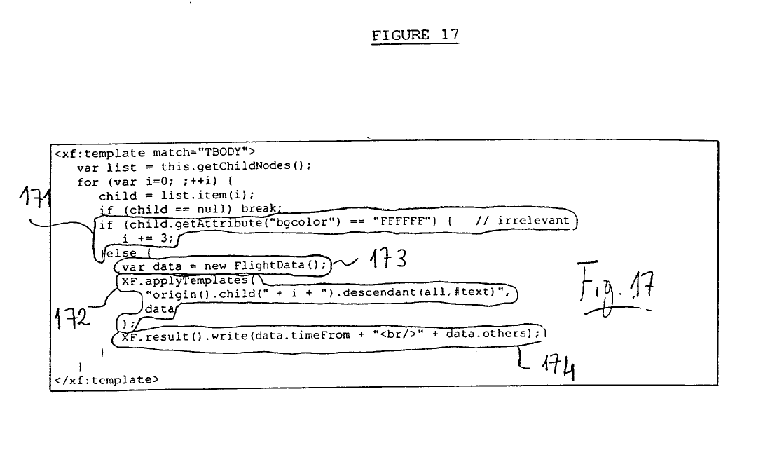

origin( ).child(i).descendant(all,#text)

where “i” is a variable indicating the line number. This equation can be interpreted to mean: Starting from the current node TBODY (“origin( )”), reach the i^{th} child node TR (“child (i)”) and apply the template corresponding to all descendants of the text type (“descendant(all,#text).). Thus, as shown in FIG. 17, the TBODY template uses an iteration loop on all lines of the table.

Some lines of the table may not exclusively contain information relating to each flight. In this case, as shown in FIG. 17, certain lines are used for formatting. These lines are passed into the script by the condition 171 and can be labeled by a white background followed by two title lines. By contrast, as shown by instruction 172, the lines of interest are the object of a call to the template procedure. The template procedure formats the content of the columns (the descendants of text type).

Still referring to FIG. 17, the first argument of the “applyTemplates( )” method is the navigation equation described above. A second argument, “data”, is an optional argument passed to all the template procedures that are applied. For this “data” argument, the programmer of the script has chosen an object 173 whose task is to collect the information contained in each line of the table. This is an ECMAScript object created by the “new” operator.

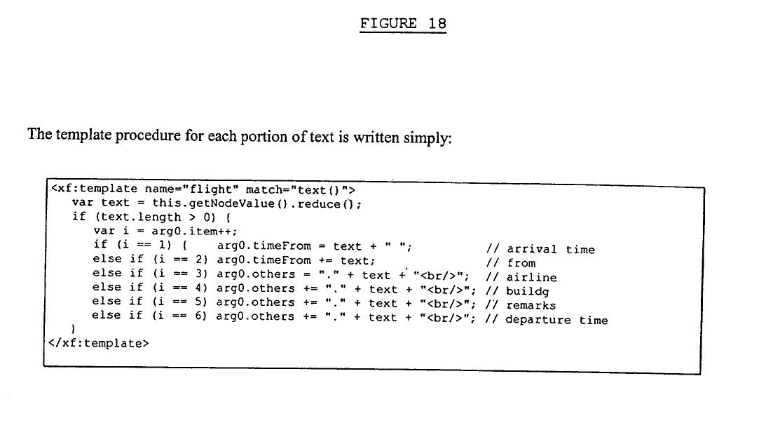

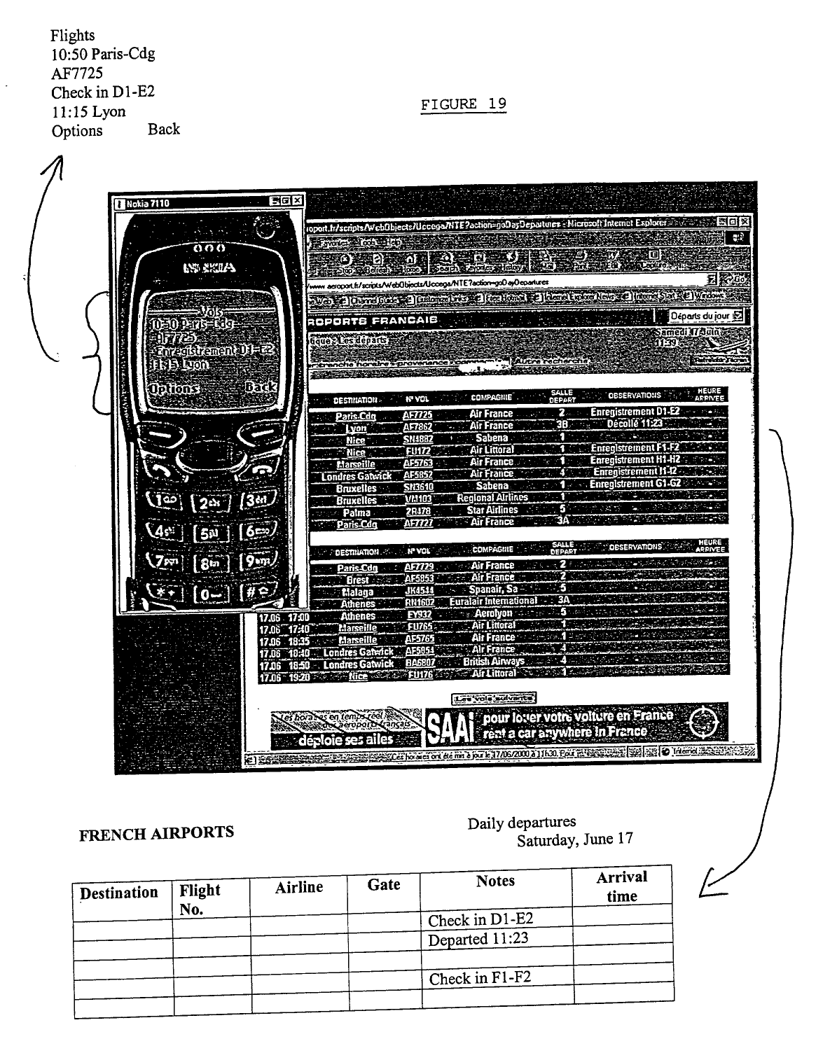

The definition of the “FlightData” object is local since it is created by the programmer of the XF script. As such, the definition of “FlightData” object is found in the content of the tag <xf:scripts>. The FlightData object collects the information associated with each line describing a flight: date, time, airport, flight number, airline, etc. Since this object is passed to the template procedure of every text type node of the table row, each field of the “data” object is completed. When the “applyTemplates( )” method is finished all these procedures have been applied, and an instruction 174 will output the textual content that it has collected to the output file. FIG. 18 illustrates a template procedure for each portion of text. FIG. 19 shows the result obtained on a Nokia□ WAP wireless communicator along with the corresponding identical information displayed on a standard web browser.

Log

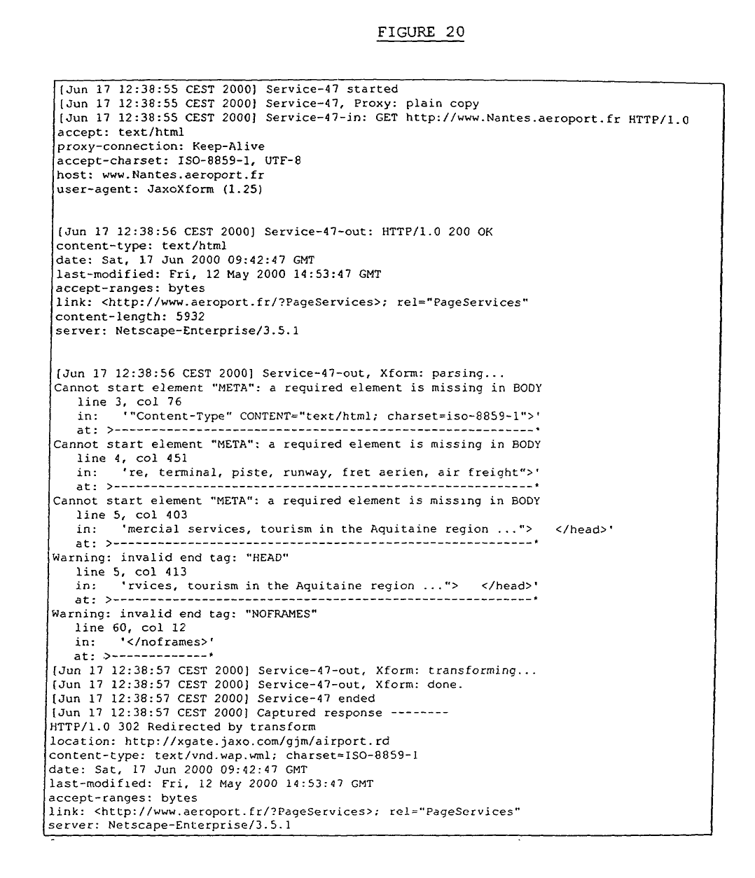

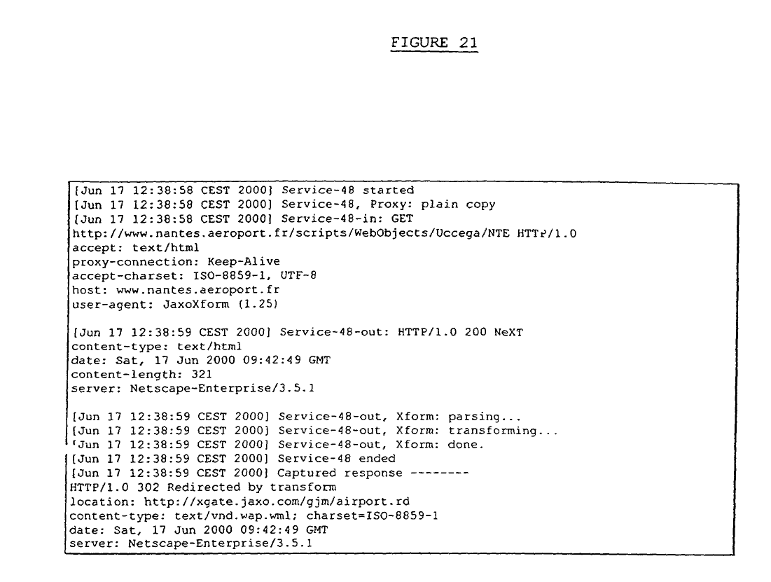

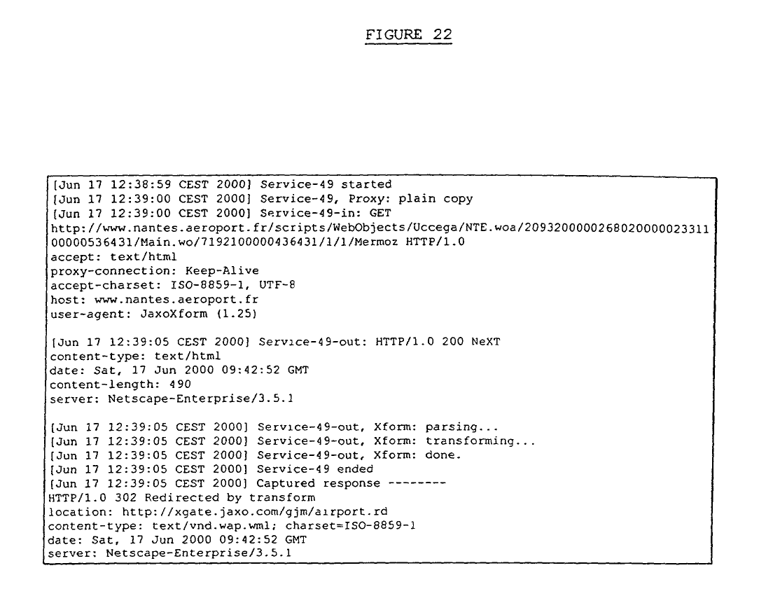

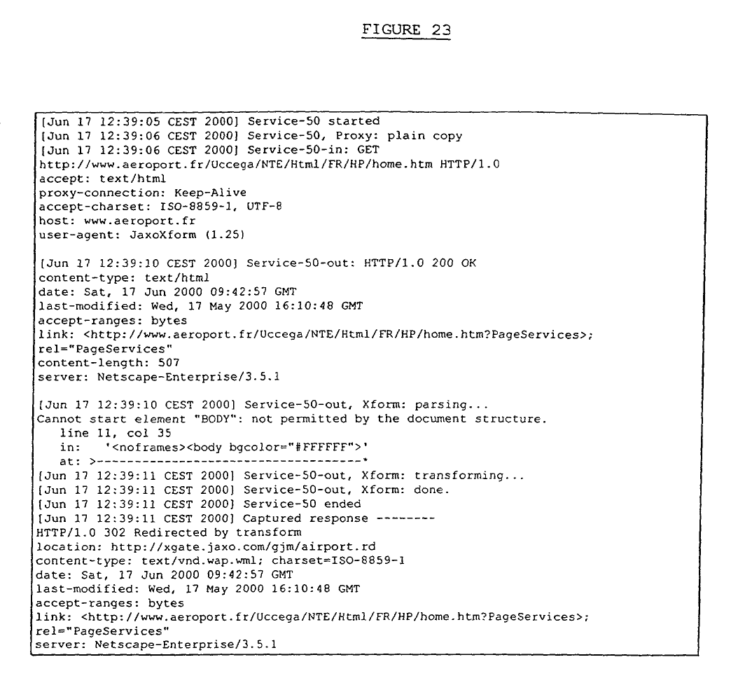

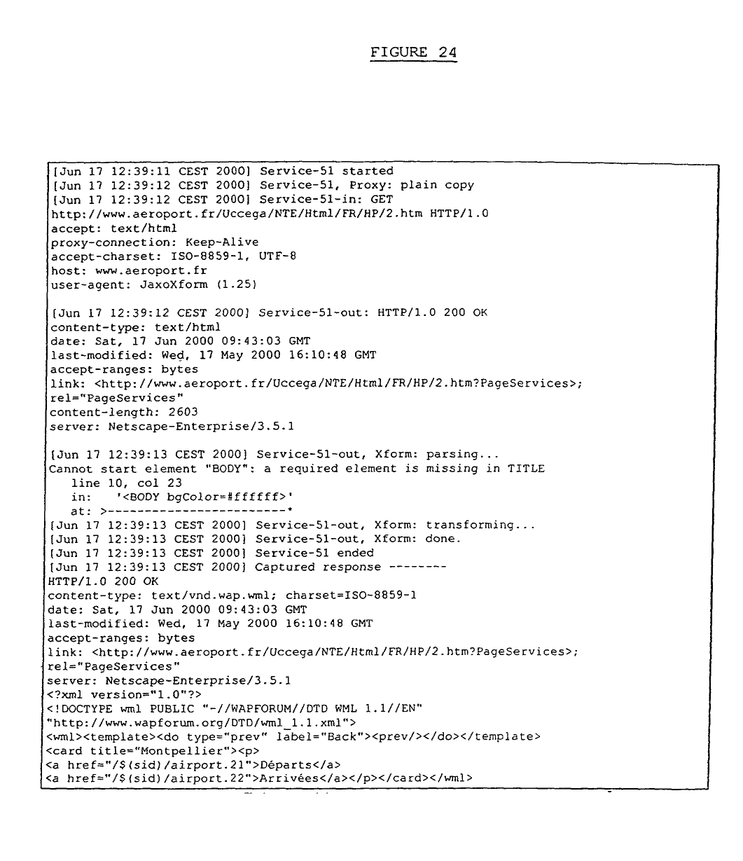

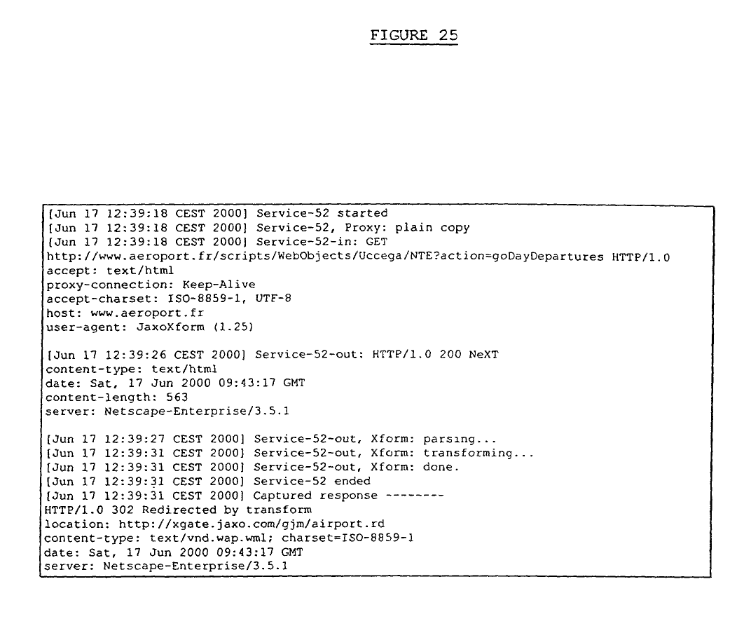

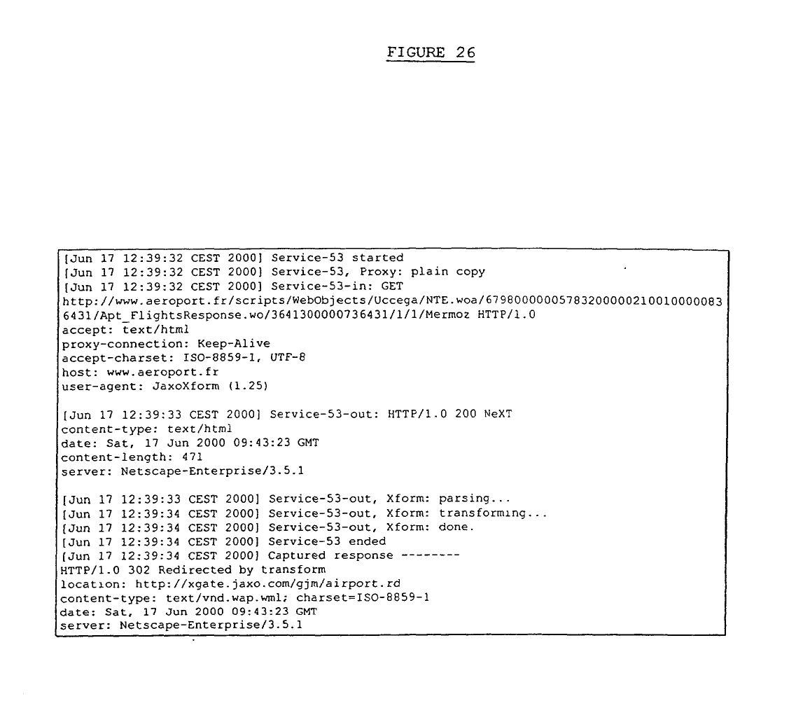

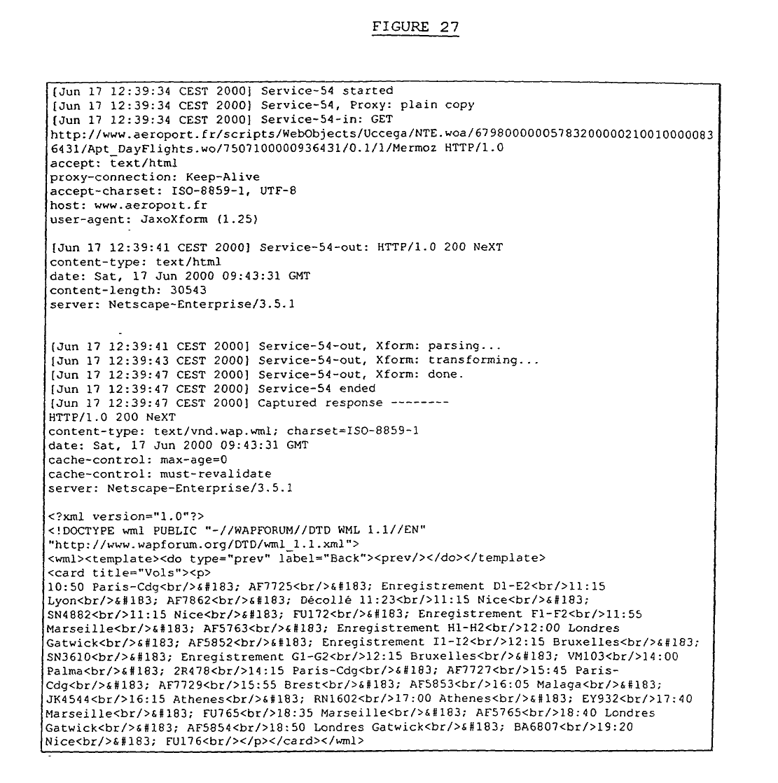

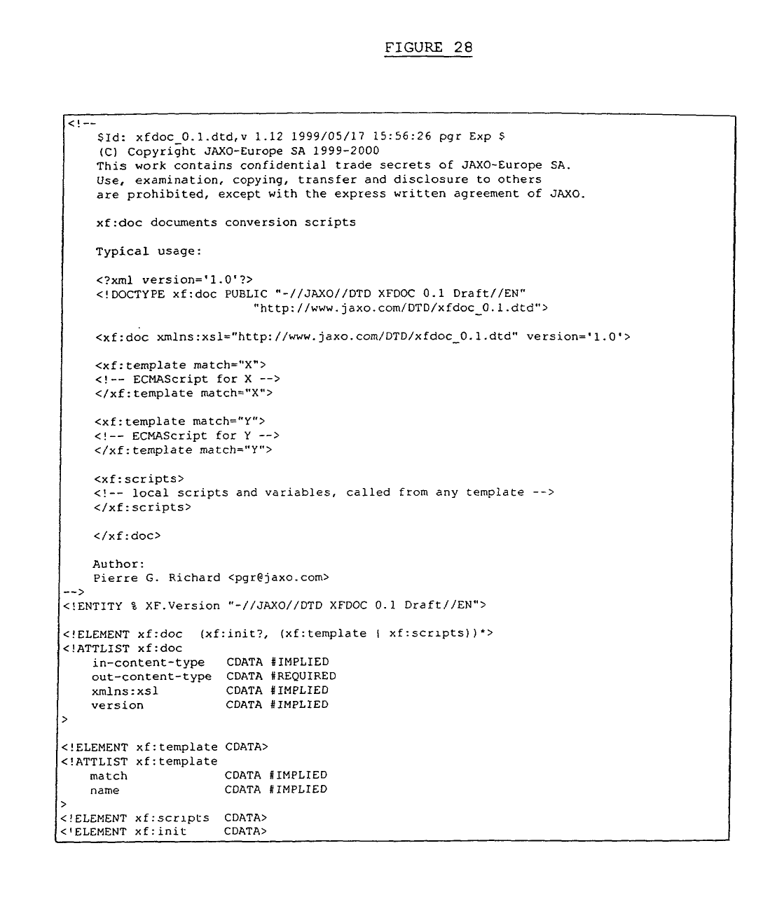

The log is a control file that provides the steps of the transformation. The log generated for the above-described example contains numerous elements that will now be described in conjunction with FIGS. 20 through 27. Shown in FIG. 20 is a first conversion in which the correction messages of the parser are recorded, and in which the result of the conversion is a redirection. FIGS. 21 through 23, respectively, show second, third and fourth conversions for other redirections. FIG. 24 shows a fifth conversion. In FIG. 24, the airport's home page has been found, and the XF conversion script returns a page in WML format to the WAP wireless communicator. This page contains two hypertext links to Departures and Arrivals. The construction “$(sid)” makes it possible to identify the user between each request. The notation “$(x)” is used in WAP telephones to indicate a reference to the internal variable “x” which XF generated in the telephone electronics. The telephone identifies itself to generator module 330 (labeled as “Broker” in FIG. 3) of the XGate converter 240. FIG. 25 illustrates that when the wireless telephone user is interested in departures, a sixth conversion takes place to provide a redirection required to obtain this information. FIG. 26 shows a seventh conversion for another redirection, and FIG. 27 shows the final conversion in which the table of departure schedules has been converted into WML format, and is sent to the WAP wireless communicator. As was seen above, the XF conversion script is encapsulated in an XML-tagged document. This type of document has a corresponding Document Type Definition (DTD) shown in FIG. 28.

As will be appreciated by those of skill in the art, the above-described aspects of the present invention in FIGS. 3 and 6 may be provided by hardware, software, or a combination of the above. While various components of the converter 240 have been illustrated in FIGS. 3 and 6, in part, as discrete elements, they may, in practice, be implemented by a microcontroller including input and output ports and running software code, by custom or hybrid chips, by discrete components or by a combination of the above.

The present invention may also take the form of a computer program product on a computer-readable storage medium having computer-readable program code means embodied in the medium. Any suitable computer readable medium may be utilized including hard disks, CD-ROMs, optical storage devices, or magnetic storage devices.

Various aspects of the present invention are illustrated in detail in the preceding Figures, including FIGS. 3 and 6. It will be understood that each block of the diagrams of FIGS. 3 and 6, and combinations of blocks, can be implemented by computer program instructions. These computer program instructions may be provided to a processor or other programmable data processing apparatus to produce a machine, such that the instructions which execute on the processor or other programmable data processing apparatus create means for implementing the functions specified in the block or blocks. These computer program instructions may also be stored in a computer-readable memory that can direct a processor or other programmable data processing apparatus to function in a particular manner, such that the instructions stored in the computer-readable memory produce an article of manufacture including instruction means which implement the functions specified in the block or blocks.

Accordingly, blocks of the block diagram illustrations of FIGS. 3 and 6 support combinations of means for performing the specified functions, combinations of steps for performing the specified functions and program instruction means for performing the specified functions. It will also be understood that each block of the illustrations of FIGS. 3 and 6, and combinations of blocks in the illustrations, can be implemented by special purpose hardware-based computer systems which perform the specified functions or steps, or by combinations of special purpose hardware and computer instructions.

In the drawings and specification, there have been disclosed typical preferred embodiments of the invention and, although specific terms are employed, they are used in a generic and descriptive sense only and not for purposes of limitation, the scope of the invention being set forth in the following claims. It will be apparent to those skilled in the art that various modifications and variations can be made in the data conversion mechanism described here without departing from the spirit or scope of the invention. In particular, the person skilled in the art will know how to adapt the principles of the invention to the new specifications which can appear in the definition of documents exchanged by a network such as the Internet, in programming, and in modeling objects. Thus, the present invention is not limited to any particular described embodiment. Instead it is intended that the present invention cover modifications and variations that come within the scope of the appended claims and their equivalents.

What is claimed:

1. A method of converting input data marked up in any one of a plurality of markup formats, comprising:
providing the input data from at least one source, the input data marked up in at least one of a plurality of markup formats; and
processing the input data directly in any one of the plurality of markup formats to transform the input data into output data in any one of the plurality of markup formats.

2. A method of converting input data as recited in claim 1, wherein processing, comprises:
generating a first request and a second request;
accessing, in response to the first request, the input data from the at least one source;
standardizing the input data to generate standardized data in one of the plurality of markup formats; and
transforming, in response to the second request, the standardized data into output data in any one of the plurality of markup formats.

3. A method of converting input data as recited in claim 2, wherein transforming comprises:
selecting at least one transformation script from a plurality of transformation scripts, wherein at least one transformation script comprises a plurality of template procedures;
reading the standardized data in one of the plurality of markup formats;
interpreting the standardized data; and
applying at least one transformation script to the standardized data in one of the plurality of markup formats to transform the standardized data into output data in any one of the plurality of markup formats applicable in a particular application.

4. A method of converting input data as recited in claim 3, wherein the input data comprises an input document having a first tree structure of nodes that represents the input data, wherein the output data comprises an output document, and wherein the step of transforming comprises:
generating the output document having a second tree structure of nodes, wherein the output document having the second tree structure of nodes corresponds to the input document having the first tree structure of nodes.

5. A method of converting input data as recited in claim 3, wherein applying the transformation script comprises:
selecting at least one template procedure from the plurality of template procedures based on an applytemplates instruction;
determining content collection actions in the at least one template procedure; and
executing selected ones of the at least one template procedure on the standardized data to construct the output data, based on the content collection actions.

6. A method of converting input data as recited in claim 4, wherein each of the template procedures is described by a template tag.

7. A method of converting input data as recited in claim 6, wherein the input document marked up in the first markup format, and wherein the output document is marked up in any one of the plurality of markup formats.

8. A method of converting input data as recited in claim 1, wherein providing the input data from at least one source comprises:
providing input data from a plurality of data sources, wherein at least one of the plurality of data sources includes input data in one of a plurality of markup formats and input data from others of the plurality of data sources in other markup formats of the plurality of markup formats.

9. A method of converting input data as recited in claim 1, wherein providing the input data is preceded by:
requesting input data in any one of the plurality of markup formats.

10. A method of converting input data as recited in claim 9, further comprising:
outputting the output data to a user in any one of the plurality of markup formats.

11. A method of converting input data as recited in claim 10, further comprising:
transferring the output data across a network to a presentation interface for display.

12. A method of converting input data as recited in claim 1, wherein the plurality of markup formats are selected from the group comprising HTML markup format, XML markup format and WML markup format.

13. A method of converting input data as recited in claim 2, wherein the standardized data is in an XML markup format.

14. A method of converting input data as recited in claim 1, wherein the input data in an input data stream and wherein the output data is an output data stream.

15. A method of converting input data as recited in claim 6, wherein generating the standardized input data in one of the plurality of markup formats is performed by a fault tolerant SGML parser, wherein the fault tolerant SGML parser provides fault-tolerant analysis of the marked up input data such that the input data conforms to XML standards, and wherein the fault tolerant SGML parser dynamically generates a tree of the resulting document that represents content of the input data.

16. A method of converting input data as recited in claim 4, wherein each of the template procedures comprises:
first selection information comprising a range of traversal of the first tree structure of the first document;
second selection information comprising a tag of the first document to which the template procedure is applied; and
at least one action from a plurality of actions.

17. A method of converting input data as recited in claim 16, wherein at least some template procedures include actions surrounded by the tag defined by the second selection information, wherein the actions collect information.

18. A method of converting input data as recited in claim 4, wherein executing comprises:
traversing selected nodes of the first tree structure, wherein selected nodes are nodes in a range defined by the first selection information of the template procedure;
determining, for each node traversed, whether a tag corresponding to the node matches the second selection information;
executing at least one corresponding action if a tag corresponding to the node matches the second selection information; and
constructing the second document based on content collection actions in the at least one template procedure that is executed.

19. A method of converting input data as recited in claim 16, wherein the actions of at least one template procedure includes instructions for calling other template procedures.

20. A method of converting input data as recited in claim 19, wherein the first selection information is based on a starting node from which the template procedure is called.

21. A method of converting input data as recited in claim 20, wherein at least one template procedure includes actions creating at least one cloistered temporary variable that is inherited by any template procedures called by the at least one template procedure.

22. A method of converting input data as recited in claim 20, wherein the template procedures include a base template procedure having the second selection information that corresponds to a root node of the tree structure of the first document such that actions of the base template procedure comprise a call of template procedures.

23. A method of converting input data as recited in claim 22, wherein the actions of the base template procedure comprises calling template procedures having second selection information that corresponds to a “body” tag.

24. A method of converting input data as recited in claim 23, wherein the tree structure of nodes of the first document comprises frame nodes, and wherein actions of the base template procedure comprise calling of template procedures having second selection information that matches a frameset tag.

25. A method of converting input data as recited in claim 24, wherein at least certain template procedures comprise at least one action of redirection toward a first different document.

26. A method of converting input data as recited in claim 25, wherein at least certain template procedures comprise at least one conditional action based on content of an access address of the first document.

27. A method of converting input data as recited in claim 26, wherein at least certain template procedures comprise at least one action constituting a method of an object and/or at least one action constituting a programmed local function.

28. A method of converting input data as recited in claim 27, wherein certain template procedures comprise a local anchoring function that converts a request, adapted to the structure of the second document, into an address of a first document containing the requested information.

29. A method of converting input data as recited in claim 28, wherein constructing the second document comprises:
writing content in certain template procedures that have second selection information that defines a content tag, wherein writing can assemble at least one part of contents of the content tag in a predetermined manner.

30. A method of converting input data as recited in claim 29, wherein the first documents comprise pages structured in a first standard markup language adapted to consultation on a client computer station via the Internet, and wherein the second documents comprise pages structured in a second standard markup language which is adapted to consultation on a portable wireless communicator.

31. A method of converting input data as recited in claim 30, wherein constructing the second document comprises:
constructing the second document in dynamic mode during a session between a wireless communicator that displays information in a structure of the second document and a server that returns information in a structure of the first document.

32. A method of converting input data as recited in claim 1, wherein the input data is marked up in an HTML markup format and wherein the output data is marked up in an HTML markup format.

33. A method of converting input data as recited in claim 1, wherein the input data is marked up in an HTML markup format and wherein the output data is marked up in an XML markup format.

34. A method of converting input data as recited in claim 1, wherein the input data is marked up in an HTML markup format and wherein the output data is marked up in a WML markup format.

35. A method of converting input data as recited in claim 1, wherein the input data is marked up in an XML markup format and wherein the output data is marked up in an XML markup format.

36. A method of converting input data as recited in claim 1, wherein the input data is marked up in an XML markup format and wherein the output data is marked up in an HTML markup format.

37. A method of converting input data as recited in claim 1, wherein the input data is marked up in an XML markup format and wherein the output data is marked up in a WML markup format.

38. A method of converting input data as recited in claim 1, wherein the input data is marked up in a WML markup format and wherein the output data is marked up in a WML markup format.

39. A method of converting input data as recited in claim 1, wherein the input data is marked up in a WML markup format and wherein the output data is marked up in an HTML markup format.

40. A method of converting input data as recited in claim 1, wherein the input data is marked up in a WML markup format and wherein the output data is marked up in an XML markup format.

41. A system adapted to convert input data marked up in any one of a plurality of markup formats, comprising:
means for providing the input data from at least one source, the input data marked up in at least one of a plurality of markup formats; and
means for processing the input data directly in any one of the plurality of markup formats to transform the input data into output data in any one of the plurality of markup formats.

42. A system adapted to convert input data as recited in claim 41, wherein means for processing, comprises:
means for generating a first request and a second request;
means for accessing, in response to the first request, the input data from the at least one source;
means for standardizing the input data to generate standardized data in one of the plurality of markup formats; and
means for transforming, in response to the second request, the standardized data into output data in any one of the plurality of markup formats.

43. A system adapted to convert input data as recited in claim 42, wherein means for generating comprises:
means for selecting at least one transformation script from a plurality of transformation scripts, wherein at least one transformation script comprises a plurality of template procedures.

44. A system adapted to convert input data as recited in claim 43, wherein means for transforming comprises:
means for reading the standardized data in one of the plurality of markup formats;
means for interpreting the standardized data; and
means for applying at least one transformation script to the standardized data in one of the plurality of markup formats to transform the standardized data into output data in any one of the plurality of markup formats applicable in a particular application.

45. A system adapted to convert input data as recited in claim 44, wherein the input data comprises an input document having a first tree structure of nodes that represents the input data, wherein the output data comprises an output document, and wherein the means for transforming comprises:
means for generating the output document having a second tree structure of nodes, wherein the output document having the second tree structure of nodes corresponds to the input document having the first tree structure of nodes.

46. A system adapted to convert input data as recited in claim 44, wherein means for applying the transformation script comprises:
means for selecting at least one template procedure from the plurality of template procedures based on an applytemplates instruction;
means for determining content collection actions in the at least one template procedure; and
means for executing selected ones of the at least one template procedure on the standardized data to construct the output data, based on the content collection actions.

47. A system adapted to convert input data as recited in claim 46, wherein the input document marked up in the first markup format, and wherein the output document is marked up in any one of the plurality of markup formats.

48. A system adapted to convert input data as recited in claim 41, wherein means for providing the input data from at least one source comprises:
means for providing input data from a plurality of data sources, wherein at least one of the plurality of data sources includes input data in one of a plurality of markup formats and input data from others of the plurality of data sources in other markup formats of the plurality of markup formats.

49. A system adapted to convert input data as recited in claim 41, wherein means for providing the input data is preceded by:
means for requesting input data in any one of the plurality of markup formats.

50. A system adapted to convert input data as recited in claim 49, further comprising:
means for outputting the output data to a user in any one of the plurality of markup formats.

51. A system adapted to convert input data as recited in claim 50, further comprising:
means for transferring the output data across a network to a presentation interface for display.

52. A system adapted to convert input data as recited in claim 41, wherein the plurality of markup formats are selected from the group comprising HTML markup format, XML markup format and WML markup format.

53. A system adapted to convert input data as recited in claim 42, wherein the standardized data is in an XML markup format.

54. A system adapted to convert input data as recited in claim 41, wherein the input data in an input data stream and wherein the output data is an output data stream.

55. A system adapted to convert input data as recited in claim 46, wherein means for standardizing the input data activates data sources to obtain the input data and wherein the means for standardizing includes a fault tolerant SGML parser adapted to generate the standardized data by providing fault-tolerant analysis of the marked up input data such that the input data conforms to XML standards, and wherein the fault tolerant SGML parser dynamically generates a tree of the resulting document that represents content of the input data.

56. A system adapted to convert input data as recited in claim 44, wherein each of the template procedure comprises:
first selection information comprising a range of traversal of the first tree structure of the first document;
second selection information comprising a tag of the first document to which the template procedure is applied; and
at least one action from a plurality of actions.

57. A system adapted to convert input data as recited in claim 56, wherein at least some template procedures include actions surrounded by the tag defined by the second selection information, wherein the actions collect information.

58. A system adapted to convert input data as recited in claim 45, wherein means for executing comprises:
means for traversing selected nodes of the first tree structure, wherein selected nodes are nodes in a range defined by the first selection information of the template procedure;
means for determining, for each node traversed, whether a tag corresponding to the node matches the second selection information;
means for executing at least one corresponding action if a tag corresponding to the node matches the second selection information; and
means for constructing the second document based on content collection actions in the at least one template procedure that is executed.

59. A system adapted to convert input data as recited in claim 56, wherein the actions of at least one template procedure includes instructions for calling other template procedures.

60. A system adapted to convert input data as recited in claim 59, wherein the first selection information is based on a starting node from which the template procedure is called.

61. A system adapted to convert input data as recited in claim 60, wherein at least one template procedure includes actions creating at least one cloistered temporary variable that is inherited by any template procedures called by the at least one template procedure.

62. A system adapted to convert input data as recited in claim 60, wherein the template procedures include a base template procedure having the second selection information that corresponds to a root node of the tree structure of the first document such that actions of the base template procedure comprise a call of template procedures.

63. A system adapted to convert input data as recited in claim 62, wherein the actions of the base template procedure comprises calling template procedures having second selection information that corresponds to a “body” tag.

64. A system adapted to convert input data as recited in claim 63, wherein the tree structure of nodes of the first document comprises frame nodes, and wherein actions of the base template procedure comprise calling of template procedures having second selection information that matches a frameset tag.

65. A system adapted to convert input data as recited in claim 64, wherein at least certain template procedures comprise at least one action of redirection toward a first different document.

66. A system adapted to convert input data as recited in claim 65, wherein at least certain template procedures comprise at least one conditional action based on content of an access address of the first document.

67. A system adapted to convert input data as recited in claim 66, wherein at least certain template procedures comprise at least one action constituting a method of an object and/or at least one action constituting a programmed local function.

68. A system adapted to convert input data as recited in claim 67, wherein certain template procedures comprise a local anchoring function that converts a request, adapted to the structure of the second document, into an address of a first document containing the requested information.

69. A system adapted to convert input data as recited in claim 48, wherein means for constructing the second document comprises:
means for writing content in certain template procedures that have second selection information that defines a content tag, wherein writing can assemble at least one part of contents of the content tag in a predetermined manner.

70. A system adapted to convert input data as recited in claim 69, wherein the first documents comprise pages structured in a first standard markup language adapted to consultation on a client computer station via the Internet, and wherein the second documents comprise pages structured in a second standard markup language which is adapted to consultation on a portable wireless communicator.

71. A system adapted to convert input data as recited in claim 70, wherein means for constructing the second document comprises:
means for constructing the second document in dynamic mode during a session between a wireless communicator that displays information in a structure of the second document and a server that returns information in a structure of the first document.

72. A system adapted to convert input data as recited in claim 41, wherein the input data is marked up in an HTML markup format and wherein the output data is marked up in an HTML markup format.

73. A system adapted to convert input data as recited in claim 41, wherein the input data is marked up in an HTML markup format and wherein the output data is marked up in an XML markup format.

74. A system adapted to convert input data as recited in claim 41, wherein the input data is marked up in an HTML markup format and wherein the output data is marked up in a WML markup format.

75. A system adapted to convert input data as recited in claim 41, wherein the input data is marked up in an XML markup format and wherein the output data is marked up in an XML markup format.

76. A system adapted to convert input data as recited in claim 41, wherein the input data is marked up in an XML markup format and wherein the output data is marked up in an HTML markup format.

77. A system adapted to convert input data as recited in claim 41, wherein the input data is marked up in an XML markup format and wherein the output data is marked up in a WML markup format.

78. A system adapted to convert input data as recited in claim 41, wherein the input data is marked up in a WML markup format and wherein the output data is marked up in a WML markup format.

79. A system adapted to convert input data as recited in claim 41, wherein the input data is marked up in a WML markup format and wherein the output data is marked up in an HTML markup format.

80. A system adapted to convert input data as recited in claim 41, wherein the input data is marked up in a WML markup format and wherein the output data is marked up in an XML markup format.

81. A system adapted to convert input data as recited in claim 42, further comprising:
means for applying logic to the output data, wherein the means for generating is responsive to a request from the means for applying logic.

82. A system adapted to convert input data as recited in claim 42, further comprising a repository module associated with the means for generating, the repository module adapted to record and provide profiles and requests that are most frequently selected.

83. A multi-tier information architecture having tiers connected by a computer network, comprising:
a data consultation tier at a client station;
an application tier on a server;
a data source tier comprising a plurality of independent data sources; and
a data aggregation tier comprising a conversion system adapted to convert input data marked up in any one of a plurality of markup formats, the conversion system including means for providing input data from at least one of the independent data sources, the input data marked up in at least one of a plurality of markup formats, and means for processing the input data directly in any one of the plurality of markup formats to transform the input data into output data in any one of the plurality of markup formats.

84. A multi-tier information architecture according to claim 83, wherein at least one of the independent data sources comprise Internet servers, rapid-access directory servers and/or database servers with query access.

85. A multi-tier information/telephone architecture having a plurality of tiers connected by a computer network and by wireless telephone network, comprising:
a data consultation tier for data consultation on a portable wireless communicator;
a transport tier for wireless data transport;
a data source tier comprising at least one data source; and
a conversion tier comprising a conversion system adapted to convert input data marked up in any one of a plurality of markup formats, the conversion system including means for providing the input data from the at least one data source, the input data marked up in at least one of a plurality of markup formats, and means for processing the input data directly in any one of the plurality of markup formats to transform the input data into output data in any one of the plurality of markup formats.

86. A multi-tier information architecture according to claim 85, wherein the of data source consists of pages structured in a standard markup language adapted to consultation on a client computer station, with the pages constituting first documents, and wherein the conversion system further comprises means for constructing second documents in a second standard markup language adapted to consultation on a portable wireless communicator.
